(19) United States
(12) Patent Application Publication
(10) Pub. No.: US 2026/0113712 A1
(43) Pub. Date: Apr. 23, 2026

(54) INTERFERENCE-AWARE UPLINK POWER CONTROL

(71) Applicant: Google LLC, Mountain View, CA (US)

(72) Inventors: Yushu Zhang, Beijing (CN); Chih-Hsiang Wu, Taipei (TW)

(21) Appl. No.: 19/113,261

(22) PCT Filed: Sep. 30, 2022
(86) PCT No.: PCT/CN2022/123593

§ 371 Date: Mar. 19, 2025

(51) Int. Cl. H04W 52/24; H04W 52/08

(52) U.S. Cl. CPC H04W 52/24; H04W 52/08

(57) ABSTRACT

This disclosure provides systems, devices, apparatus, and methods, including computer programs encoded on storage media, for interference-aware uplink power Control. A UE (302) receives (306) a first control signal indicating a plurality of power control parameter sets. The UE (302) receives (308) a second control signal to trigger an uplink signal based on at least one of the plurality of power control parameter sets. The UE (302) transmits (314) the uplink signal with a transmission power determined based on the at least one of the plurality of power control parameter sets.

### TECHNICAL FIELD

The present disclosure relates generally to wireless communication, and more particularly, to uplink power control to control the uplink transmission power.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a network entity, such as a base station (BS), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. As mobile broadband technologies evolve, improvements in mobile broadband have been useful to continue the progression of such technologies. For example, it is difficult to determine the transmission power of the UE for a multiple transmission and reception point (mTRP) system.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

Using uplink power control, the BS instructs the UE to modify its transmission power so that the BS can achieve a target receiving power with limited generated interference to other receivers. For an mTRP system, the UE has connections to more than one TRP. A TRP can be an antenna array belonging to an RU, a combination RU/DU, or a BS. The pathloss between the UE and each TRP could be different. Conventional uplink power control, however, is based on the link quality between the UE and only one TRP in the mTRP system. When the UE determines the transmission power for an uplink signal toward only one TRP, it is not controlling the signal power to other TRPs. In addition, if the uplink signal is intended for receipt by multiple TRPs, conventional uplink power control cannot identify a proper transmission power with regard to different link qualities between the UE and the different target TRPs. Therefore, there is an opportunity to configure the power control parameters with regard to interference toward additional TRPs in the mTRP system.

The present disclosure addresses the above-noted and other deficiencies by using an interference-aware uplink power control. Based on UE capabilities for interference-aware uplink power control, the network entity configures the interference-aware uplink power control and transmits a control signal indicating multiple uplink power control parameter sets. Then, the network entity triggers an uplink signal, with or without further down-selection of the uplink power control parameter sets. The UE determines the transmission power for the uplink signal based on the selected one or more uplink power control parameter sets. Afterwards, the UE transmits the uplink signal based on the determined transmission power. The UE further determines the power headroom (PH) and transmits the PH report (PHR) based on the selected one or more uplink power control parameter sets.

Advantageously, the interference-aware uplink power control includes multiple uplink power control parameter sets. When the UE determines the transmission power for an uplink signal toward one TRP, it controls the interference to other TRPs as directed by an uplink power control parameter sets. In addition, if the uplink signal is toward multiple TRPs, the UE determines a proper transmission power with regard to different pathloss statuses between the UE and different target receiving TRPs.

According to some aspects, a UE receives a first control signal indicating a plurality of power control parameter sets. The UE receives a second control signal to trigger an uplink signal based on at least one of the plurality of power control parameter sets. The UE transmits the uplink signal with a transmission power determined based on the at least one of the plurality of power control parameter sets.

According to some aspects, a network entity transmits a first control signal indicating a plurality of power control parameter sets. The network entity transmits a second control signal to trigger an uplink signal based on at least one of the plurality of power control parameter sets. The network entity receives the uplink signal with a transmission power determined based on at least one of the plurality of power control parameter sets.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system including a plurality of network entities in communication over a plurality of cells.

FIG. 2 is a diagram that illustrates an mTRP system including a UE and multiple TRPs.

FIG. 3A illustrates a signaling diagram for an interference-aware uplink power control procedure.

FIG. 3B illustrates a signaling diagram for an example of an interference-aware uplink power control procedure for a UE in a dual-connectivity (DC) mode.

FIG. 3C illustrates a signaling diagram for another example of an interference-aware uplink power control procedure for a UE in a DC mode.

FIG. 4A is a diagram illustrating an example of an interference-aware uplink power control with a plurality of power control parameter sets.

FIG. 4B is a diagram illustrating an example of an interference-aware uplink power control with a plurality of power control parameter sets for signal reception and interference suppression.

FIG. 4C is a diagram illustrating an example of an interference-aware uplink power control with two lists of power control parameter sets, a first list signal reception and a second list for interference suppression.

FIG. 5 is a flowchart of a method of interference-aware uplink power control at a UE.

FIG. 6 is a flowchart of a method of interference-aware uplink power control at a network entity.

FIG. 7 is a diagram illustrating an example of a hardware implementation for an example UE apparatus.

FIG. 8 is a diagram illustrating an example of a hardware implementation for one or more example network entities.

### DETAILED DESCRIPTION

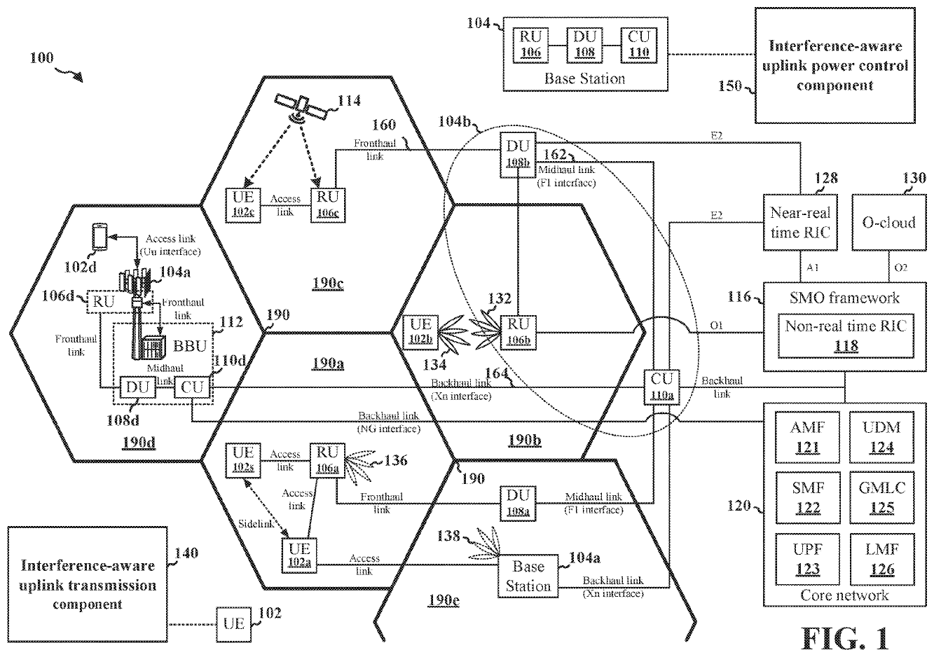

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an AI link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104a communicates with the CU 110a of the base station 104b over the backhaul link based on the Xn interface. Similarly, the base station 104a of the cell 190c may communicate with the CU 110a of the base station 104b over a backhaul link based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link between the RU 106d and the baseband unit (BBU) 112 of the cell 190d or, more specifically, the fronthaul link between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the AI interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the AI link. The near-real time RIC 128 may utilize the parameters and/or other information received from the non-real time RIC 118 or the SMO framework 116 via the AI link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems. Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190e may receive the beamformed signal from the RU 106a based on a base station beam set 138 in one or more receive directions of the base station 104a. Similarly, the base station 104a of the cell 190e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell identifier (ID) (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Tings (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 includes an interference-aware uplink transmission component 140 configured to receive a first control signal indicating a plurality of power control parameter sets, and to receive a second control signal to trigger an uplink signal based on at least one of the plurality of power control parameter sets. The interference-aware uplink transmission component 140 is further configured to transmit the uplink signal with a transmission power determined based on the at least one of the plurality of power control parameter sets.

In certain aspects, the base station 104 or a network entity of the base station 104 includes an interference-aware uplink power control component 150 configured to transmit a first control signal indicating a plurality of power control parameter sets, and to transmit a second control signal to trigger an uplink signal based on at least one of the plurality of power control parameter sets. The interference-aware uplink power control component 150 is further configured to receive the uplink signal with a transmission power determined based on at least one of the plurality of power control parameter sets.

Although the following description may be focused on 5G NR, the concepts described herein may be applicable to other similar areas, such as 5G-Advanced and future versions, LTE, LTE-advanced (LTE-A), and other wireless technologies. The wireless communications system of FIG. 1 may be used to implement aspects of the subsequent figures.

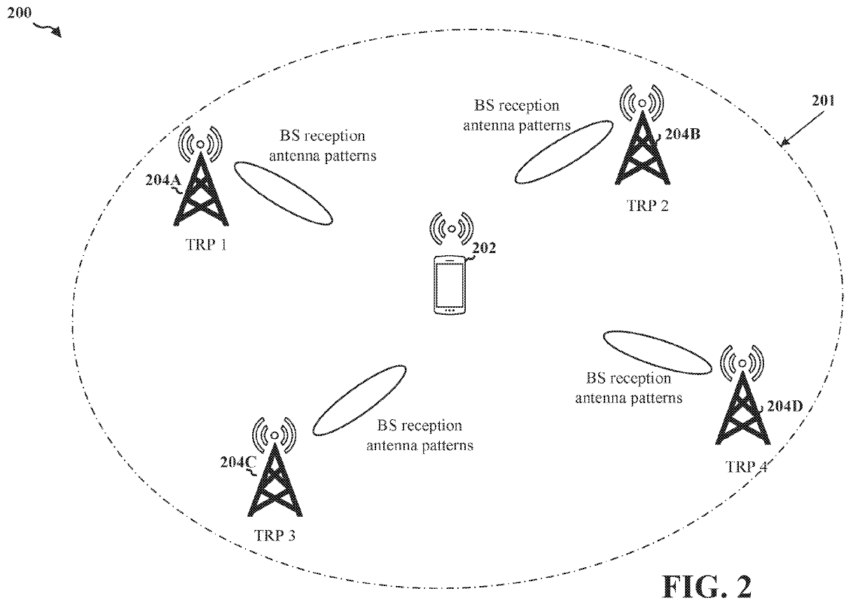

FIG. 2 is a diagram 200 that illustrates an mTRP system 201 including a UE 202 and multiple TRPs 204A, 204B, 204C, 204D. The mTRP system 201 of a network entity 204 uses more than one transmission and reception point (TRP) to communicate with the UE 202. The network entity 204 may correspond to the base station 104 or an entity at the base station 104, such as the RU 106, the DU 108, the CU 110, etc. A TRP can be an antenna array belonging to an RU, a combination RU/DU, or a BS. The mTRP system 201 of the network entity 204 includes multiple TRPs 201A, 204B. 204C, 204D. The UE 202 may correspond to the UE 102. Using uplink power control, the network entity 204 instructs the UE 202 to modify its transmission power so that the network entity 204 can achieve a target receiving power with limited generated interference to other receivers.

For an uplink transmission occasion i, the UE can determine the uplink transmission power as follows:

$${P}_{Tx} ( i ) = min \{ {P}_{CMAX} ( i ) , {P}_{0} + α \times P L + {Δ}_{BW} + {Δ}_{TF} + f ( i ) \} ,$$

where P_{CMAX}(i) indicates the maximum transmission power at transmission occasion i; P₀ is the target receiving power spectrum density; a is a fractional power control factor, 0<α≤1; Δ_{BW} is the bandwidth factor, in one example, Δ_{BW}=10(2^{u}M_{RB}), where u indicates the subcarrier spacing scaling factor and M_{RB} denotes the number of scheduled RBs; Δ_{TF} is the transmission format (TF) factor, which is determined by the transmission format for the uplink channel, e.g. modulation and coding scheme; f(i) is the closed-loop power control factor; PL is the pathloss measured based on a pathloss reference signal.

For an uplink bandwidth part (BWP), the network entity can configure N sets of power control parameters by RRC signaling. For example, a RRC signaling may indicate a RRC reconfiguration message from the network entity to the UE, or a system information block (SIB), where the SIB can be an existing SIB (e.g., SIB1) or a new SIB (e.g., SIB J, where J is an integer above 21) transmitted by the network entity. Each set of power control parameters include P0, α, pathloss reference signals, and the loop index for closed-loop power control. For unified Transmission Configuration Indicator (TCI) based beam management framework, the network entity can configure a pathloss reference signal and a set of power control parameters including P0, α, and closed-loop index associated with a unified TCI state. In one example, the RRC signaling is as follows, where pathlossReferenceRS-Id-r17 indicates the pathloss reference signal for power control, p0AlphaSetforPUSCH-r17 indicates the P0, α and the closed-loop power control index for Physical Uplink Shared Channel (PUSCH), p0AlphaSetforPUCCH-r17 indicates the P0, α and the closed-loop power control index for Physical Uplink Control Channel (PUCCH), p0AlphaSetforSRS-r17 indicates the P0, α and the closed-loop power control index for Sounding Reference Signal (SRS). The UE performs the uplink power control for the corresponding uplink channel based on the power control parameters associated with the indicated TCI.

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...,
[[

| | |
|---|---|
| additionalPCI-r17 | AdditionalPCIIndex-r17 |

OPTIONAL, -- Need R

| | |
|---|---|
| pathlossReferenceRS-Id-r17 | PUSCH-PathlossReferenceRS-Id |

OPTIONAL, -- Cond JointTCI

| | |
|---|---|
| ul-powerControl-r17 | Uplink-powerControlId-r17 |

OPTIONAL -- Cond JointTCI
]]
}

| | |
|---|---|
| Uplink-powerControl-r17 ::= | SEQUENCE { |
| ul-powercontrolId-r17 | Uplink-powerControlId-r17, |
| p0AlphaSetforPUSCH-r17 | P0AlphaSet-r17 |

OPTIONAL, -- Need R

| | |
|---|---|
| p0AlphaSetforPUCCH-r17 | P0AlphaSet-r17 |

OPTIONAL, -- Need R

| | |
|---|---|
| p0AlphaSetforSRS-r17 | P0AlphaSet-r17 |

OPTIONAL -- Need R
}

| | |
|---|---|
| P0AlphaSet-r17 ::= | SEQUENCE { |
| p0-r17 | INTEGER (−16..15) |

OPTIONAL, -- Need R

| | |
|---|---|
| alpha-r17 | Alpha |

OPTIONAL, -- Need R

| | |
|---|---|
| closedLoopIndex-r17 | ENUMERATED { i0, i1 } |

}
Uplink-powerControlId-r17 ::= INTEGER(1.. maxUL-TCI-r17)

The network entity 204 can indicate a unified TCI state for physical uplink shared channel (PUSCH)/physical uplink control channel (PUCCH). Then the UE 202 should determine the transmission power for the PUSCH/PUCCH based on the power control parameters associated with the indicated unified TCI state. The network entity 204 can indicate a unified TCI state for a sounding reference signal (SRS) resource. To keep the same transmission power for SRS resources within an SRS resource set, the UE 202 determines the transmission power for the SRS resources in an SRS resource set based on the power control parameters associated with the unified TCI state applied to the SRS resource with the lowest resource ID within the SRS resource set. If the gNB does not configure a power control parameter set associated with an indicated unified TCI state, a default power control parameter set is applied for uplink power control. In one example, the default power control parameter set is the power control parameters associated with the lowest Uplink-powerControlId, and PUSCH-PathlossReferenceRS-Id.

The UE 202 can report power headroom (PH) to assist the network's uplink scheduling, where the PH can provide the information on the remaining power for the UE to use in addition to the power being used for one transmission occasion. Multiple types of PH have been defined (Type2 PH is reserved for PUCCH). For example, Type 1 PH is measured based on PUSCH. Type 3 PH is measured based on SRS. The PH can be measured based on an actual transmission occasion or a reference transmission occasion. For PH measured from an actual transmission occasion i, the actual PH is calculated as follows:

$$P H ( i ) = {P}_{CMAX} ( i ) - \{ {P}_{0} + α \times P L + {Δ}_{BW} + {Δ}_{TF} + f ( i ) \} .$$

For PH measured from a reference transmission occasion i, the reference PH is calculated as follows:

$$\tilde{P H} ( i ) = {\tilde{P}}_{CMAX} ( i ) - \{ {\tilde{P}}_{0} + \tilde{α} \times + \tilde{f} ( i ) \} ,$$

where \tilde{P}_{CMAX}(i) indicates a reference maximum transmission power with power reduction factors equal to 0 dB, and the other parameters P̌₀, \tilde{α}, [symbol] , and f(i), are determined based on the power control parameters associated with the indicated unified TCI state or based on a default power control parameter set. If there is an actual transmission occasion for the corresponding uplink channel, e.g., PUSCH/SRS, after the PH report (PHR) triggering time and before the minimal preparation delay for PHR, the UE can report actual PH in the PHR; otherwise, UE reports reference PH in the PHR.

The UE 202 can trigger a PHR, e.g., the UE can transmit the PH report (PHR) by MAC control element (CE) or transmit a scheduling request (SR) to request uplink resource for PHR, if any of the following events happens:
Event 1: The PHR prohibit timer, e.g., phr-ProhibitTimer, expires or has expired and the pathloss has changed more than a configured threshold, e.g., phr-Tr-PowerFaclorChange dB, for at least one RS used as pathloss reference for one activated Serving Cell of any MAC entity of which the active downlink BWP is not dormant BWP since the last transmission of a PHR in this MAC entity when the MAC entity has uplink resources for new transmission,
Event 2: The timer for periodic PHR. e.g., phr-PeriodicTimer, expires
Event 3: Upon configuration or reconfiguration of the power headroom reporting functionality by upper layers, e.g., RRC layer, which is not used to disable the function;
Event 4: Activation of a secondary cell (SCell) of any MAC entity with configured uplink of which firstActiveDownlinkBWP-Id is not set to dormant BWP;
Event 5: Activation of a secondary cell group (SCG);
Event 6: Addition of the primary secondary cell (PSCell) except if the SCG is deactivated (e.g., PSCell is newly added or changed);
Event 7: The PHR prohibit timer, e.g., phr-ProhibitTimer, expires or has expired, when the MAC entity has UL resources for new transmission, and the following is true for any of the activated Serving Cells of any MAC entity with configured uplink. There are UL resources allocated for transmission or there is a PUCCH transmission on this cell, and the required power backoff due to power management for this cell has changed more than a configured threshold, e.g., phr-Tx-PowerFactorChange dB, since the last transmission of a PHR when the MAC entity had UL resources allocated for transmission or PUCCH transmission on this cell.
Event 8: Upon switching of activated BWP from dormant BWP to non-dormant DL BWP of an SCell of any MAC entity with configured uplink;
Event 9: The maximum power emission (MPE) related report is enabled, e.g. mpe-Reporting-FR2 is configured, and the prohibit timer for MPE report. e.g. mpe-ProhibitTimer, is not running. The measured power management power reduction (P-MPR) applied to meet FR2 MPE requirements is equal to or larger than a first configured threshold, e.g., mpe-Threshold, for at least one activated FR2 Serving Cell since the last transmission of a PHR in this MAC entity; or the measured P-MPR applied to meet FR2 MPE requirements has changed more than a second configured threshold, e.g., phr-Tx-PowerFactorChange dB, for at least one activated FR2 Serving Cell since the last transmission of a PHR due to the measured P-MPR applied to meet MPE requirements being equal to or larger than the first configured threshold, e.g. mpe-Threshold, in this MAC entity.

Referring to FIG. 2, for the mTRP system 201, the UE 202 may communicate with TRPs 204A. 204B, 204C, 204D. The pathloss between the UE 202 and the TRPs 204A, 204B, 204C, 204D could be different. The UE 202 may need to transmit some uplink signals to each TRP. In one example, for downlink coherent joint transmission based mTRP operation, the network entity 204 can trigger the UE 202 to transmit SRS for antenna switching to each TRP for downlink channel state information (CSI) measurement based on uplink/downlink channel reciprocity. In another example, the network entity 204 may trigger the UE 202 to transmit PUSCH/PUCCH to one or more TRPs. Then the one or more TRPs can perform independent or joint decoding for the PUSCH/PUCCH. This operation can improve the reliability for the uplink transmission.

It is challenging to overcome the problems of conventional uplink power control, which is based on the link quality between the UE and only one TRP in the mTRP system and is not controlling the signal power to other TRPs. For example, if the pathloss to TRP1 204A is large, the UE needs to increase the transmission power, which could generate more interference to other neighbor TRPs. In addition, conventional uplink power control cannot identify a proper transmission power with regard to different link qualities between the UE and the different target TRPs.

By using an interference-aware uplink power control procedure, the network entity 204 configures the power control parameters with regard to interference toward other TRPs in the mTRP system 201, as well as different reception operation. e.g., one target receiving TRP or more than one target receiving TRPs. The network entity 204 transmits control signals indicating configuration and selection of a plurality of uplink power control parameter sets configuration and selection. The UE 202 determines the transmission power with regard to the link quality between the UE and more than 1 TRPs. The UE 202 determines PHR triggering event and PH calculation based on the configured/selected uplink power control parameter sets. The details of the interference-aware uplink power control in the mTRP system will be discussed below.

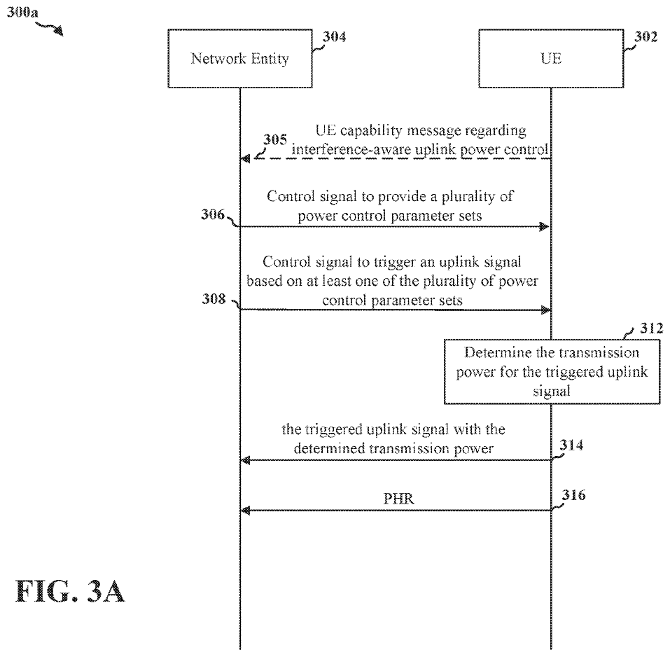

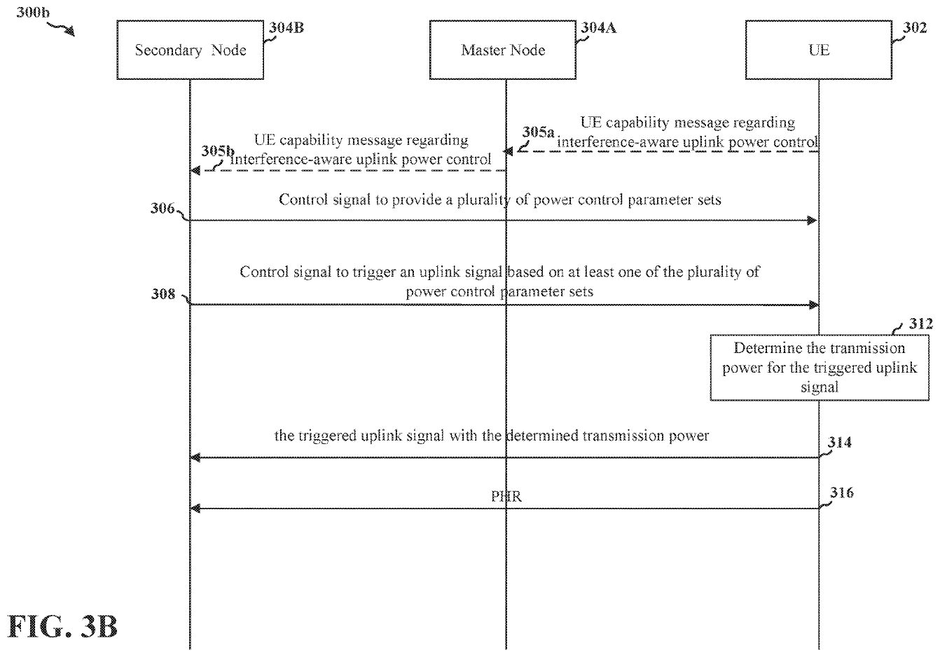

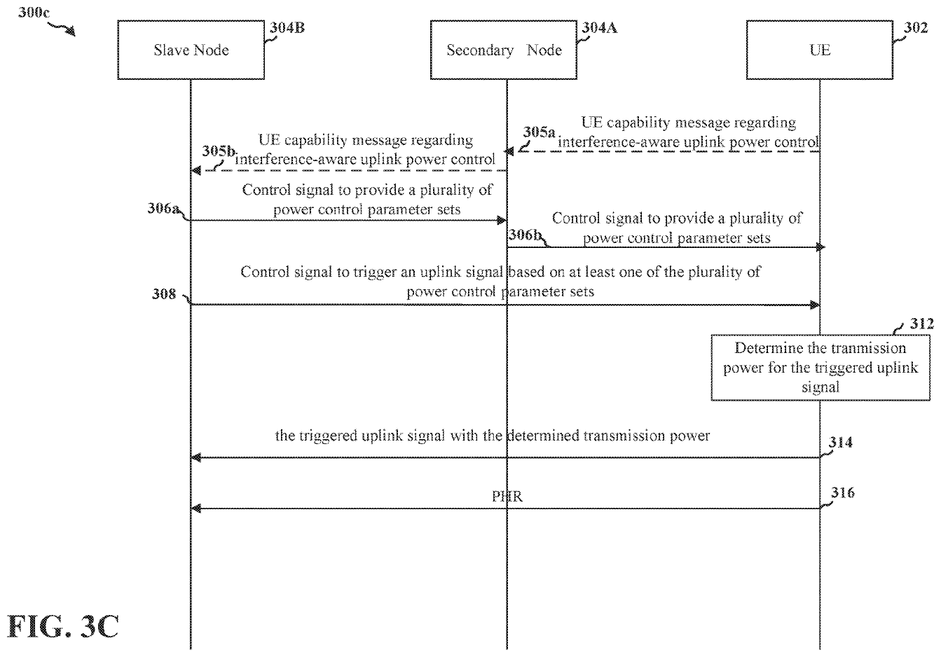

FIGS. 3A-3B illustrate signaling diagrams for an interference-aware uplink power control procedure between one or more network entities (304, 304A. 304B) and the UE 302. The one or more network entities (304, 304A, 304B) may correspond to the base station 104 or an entity at the base station 104, such as the RU 106, the DU 108, the CU 110, etc. The UE 302 may correspond to the UE 102. During the interference-aware uplink power control procedure, the one or more network entities (304, 304A, 304B) transmit a first control signal indicating a plurality of power control parameter sets. The one or more network entities (304, 304A, 304B) transmit a second control signal to trigger an uplink signal based on at least one of the plurality of power control parameter sets. The UE transmits the uplink signal with a transmission power determined based on the at least one of the plurality of power control parameter sets.

Referring to FIG. 3A, which illustrates a signaling diagram 300a for the interference-aware uplink power control procedure between the network entity 304 and the UE 302. The network entity 304 may correspond to the base station 104 or an entity at the base station 104, such as the RU 106, the DU 108, the CU 110, etc. As illustrated in FIG. 3A, the network entity 304 transmit 306 a first control signal indicating a plurality of power control parameter sets to the UE 302. The network entity 304 transmits 308 a second control signal to trigger an uplink signal based on at least one of the plurality of power control parameter sets. The UE 302 transmits the uplink signal with a transmission power determined based on the at least one of the plurality of power control parameter sets.

In some examples, the UE 302 might report 305 one or more capabilities regarding the interference-aware uplink power control to the network entity 304. The one or more capabilities indicate UE support for the interference-aware uplink power control, the maximum number of uplink power control parameter sets that can be applied for uplink power control for a transmission (e.g., a PUSCH/PUCCH/SRS transmission occasion), the maximum number of pathloss reference signals for the transmission, and/or support for a power headroom report (PHR) based on a plurality of power control parameter sets. For example, the UE capability may include at least one of the following elements: whether the UE supports the interference-aware uplink power control for a PUSCH/PUCCH/SRS transmission occasion, the maximum number of power control parameter sets applied for a PUSCH/PUCCH/SRS transmission occasion, the maximum number of pathloss reference signals applied for a PUSCH/PUCCH/SRS transmission occasion, and whether to support PHR based on more than one power control parameter sets. The UE capabilities may be reported per feature set, per band, per band combination and/or per UE. In other examples, the network entity 304 might receive the one or more capabilities from a core network (e.g., AMF 121) (not shown).

Based on the one or more capabilities, the network entity 304 configures the interference-aware uplink power control by configuring more than one uplink power control parameter sets for an uplink channel or resource. The network entity 304 transmits 306 the control signaling regarding the interference-aware power control based on the multiple uplink power control parameter sets by higher layer signaling, e.g., RRC signaling.

As illustrated in FIG. 3A, the network entity 304 transmits 306 a first control signal to the UE 302 to provide the multiple uplink power control parameter sets for the uplink channel or resource. In some examples, the network entity 304 might transmit, to the UE 302, a RRC message (e.g., RRCReconfiguration message) including the interference-aware uplink power control related aspects such as the multiple one uplink power control parameter sets.

The first power control parameter set may include a first target receiving power spectrum density (P0), a first fractional power control factor (a), first pathloss reference signals, and a first closed-loop index. The other power control parameter set(s) may include at least one of the elements of P0, α, pathloss reference signals, or the closed-loop index. For example, the second power control parameter set may include at least one of: a second target receiving power spectrum density (P0), a second fractional power control factor (α), second pathloss reference signals, or a second closed-loop index for closed-loop power control. For the power control parameters not included in the other power control parameter sets, the corresponding power control parameters in the first set of power control parameter set or a default power control parameter set, e.g., the power control parameter set with the lowest set ID, may be applied. As an example, when the second power control parameter set is missing a power control parameter, a corresponding power control parameter in the first power control parameter set may be used for power control.

In some examples, the network entity 304 configures more than one power control parameter sets and/or more than one pathloss reference signal associated with a unified TCI state. The more than one power control parameter sets are associated with the unified TCI. An association between one or more power control parameter sets and a unified TCI state can be based on the one or more power control parameter sets being configured in the unified TC state. For example, the network entity 304 transmits 306 the first control signal including the unified TCI state, which indicates the more than one power control parameter sets (e.g., RRC parameters). A “TCI state” refers to a set of parameters for configuring a quasi co-location (QCL) relationship between one or more downlink reference signals and corresponding antenna ports. For example, the TCI state can be indicative of a QCL relationship between downlink reference signals in a CSI-RS set and physical downlink shared channel (PDSCH) demodulation reference signal (DMRS) ports. Due to the theorem of antenna reciprocity, a single TCI state might provide beam indications for both downlink channels/signals and uplink channels/signals. In some other examples, the network entity 304 may configure more than one pathloss reference signals and more than one power control parameter sets by configuring more than one TCI states for uplink channels. The first control signal further indicates a plurality of unified TC states, and each power control parameter set is associated with one unified TCI state.

In some examples, the network entity 304 configures whether the multiple power control parameter sets based power control is enabled for an uplink channel or an uplink resource or resource set by RRC signalling. In one example, the network entity 304 may enable or disable the multiple power control parameter sets based power control for the PUSCH/PUCCH/SRS transmission by separate RRC parameters. For an uplink channel/signal with the unified TC indicating multiple power control parameter sets or multiple pathloss reference signals, but with the multiple power control parameter sets based power control as ‘disable’, the first configured power control parameter set or the first configured pathloss reference signal may be applied.

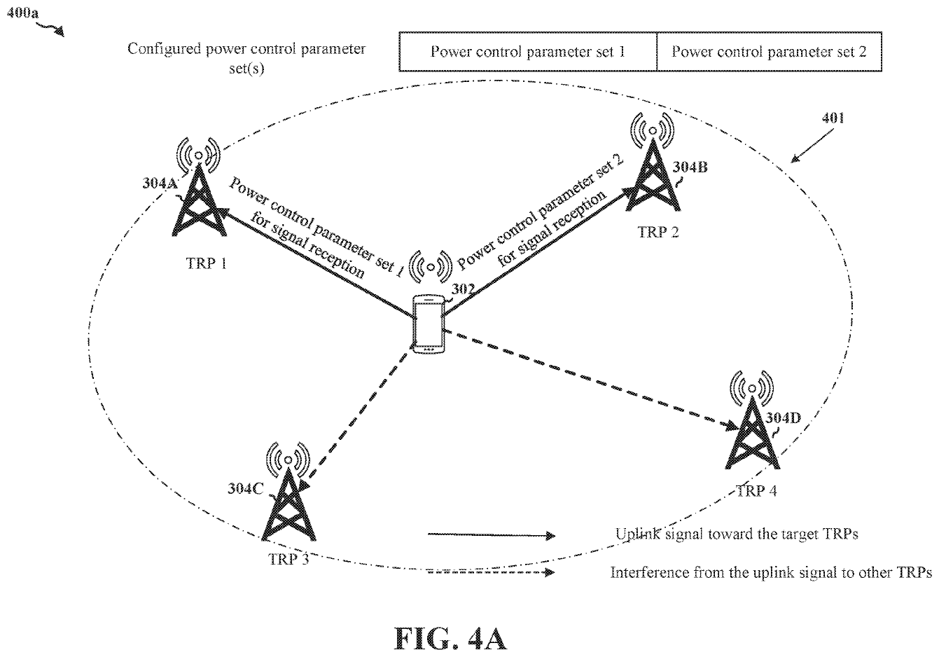

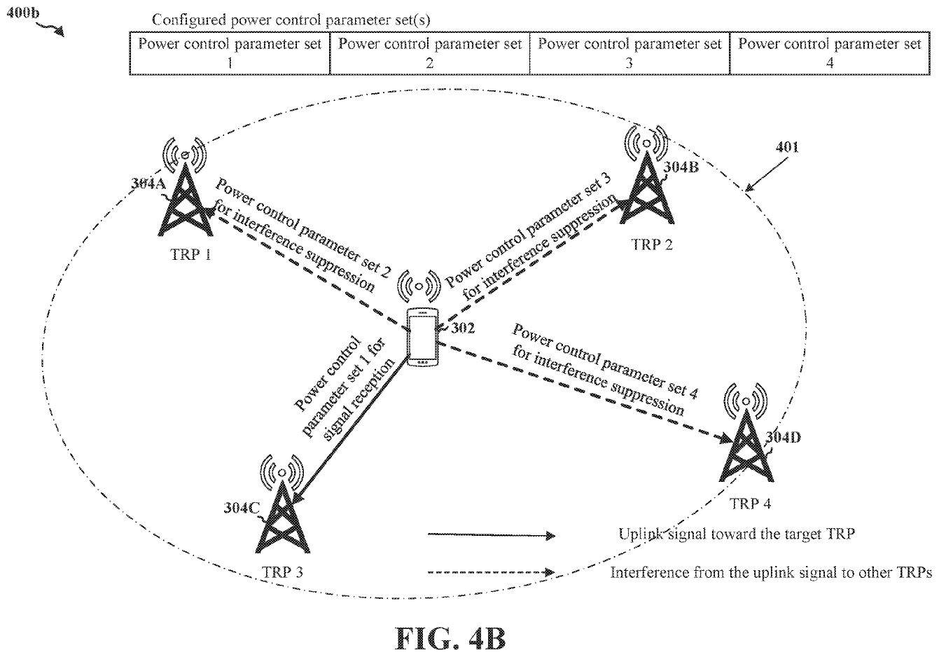

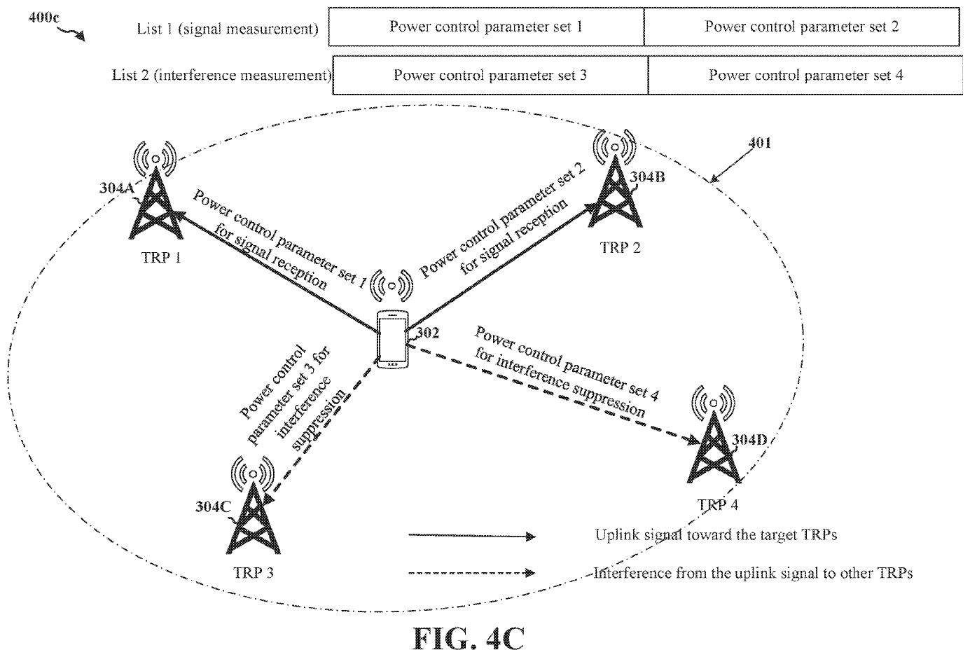

In one example, the network entity 304 configures the power control parameter sets and pathloss reference signals for one or more target receiving TRPs. FIG. 4A is a diagram 400a illustrating an example of a configuration of the plurality of power control parameter sets for interference-aware uplink power control. Referring to FIG. 4A, an mTRP system 401 of the network entity 304 uses more than one TRP to communicate with the UE 302. The mTRP system 401 of the network entity 304 includes multiple TRPs 304A. 304B, 304C, 304D. The one or more target receiving TRPs may include TRP1 304A and TRP2 304B.

As illustrated in FIG. 4A, in this example, the network entity 304 configures the power control parameter sets and pathloss reference signals for one or more target receiving TRPs, where the configured power control parameter sets are used for the target receiving TRPs, TRP1 304A and TRP2 304B. The network entity 304 transmits 306 the first control signal to the UE 302 to provide a first power control parameter set for the target receiving TRP1 304A and a second power control parameter set for the target receiving TRP2 304B. The UE 302 transmits the uplink signal towards the target receiving TRP1 304A and TRP2 304B using the two power control parameter sets. However, the uplink signal might cause interference to other TRPs, e.g., TRP3 304C and TRP4 304D.

FIG. 4B is a diagram 400b illustrating another example of a configuration of a plurality of power control parameter sets in the interference-aware uplink power control. In this example, the network entity 304 configures one power control parameter set and pathloss reference signal for each of the one or more target receiving TRPs, and one or more power control parameter sets and pathloss reference signals for each of the victim TRPs for interference suppression. Referring to FIG. 4B, in this configuration, the target receiving TRP 3 304C uses the first configured power control parameter set, and the victim TRPs, TRP1 304A, TRP2 304B and TRP4 304D, use the remaining 3 power control parameter sets for interference suppression.

The network entity 304 may provide a list of pathloss reference signal IDs and/or a list of uplink power control IDs. In some examples, if the list of pathloss reference signal IDs (e.g., pathlossReferenceRsIdList) is provided, the pathlossReferenceRS-Id might not be provided. In some other examples, if the list of uplink power control IDs (e.g., ul-powerControlList) is provided, the ul-powerControl-r17 might not be provided. An example code of the RRC signaling could be as follows:

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PUSCH-PathlossReferenceRS-Id |

OPTIONAL, -- Cond JointTCI

| | |
|---|---|
| ul-powerControl-r17 | Uplink-powerControlId-r17 |

```
OPTIONAL -- Cond JointTCI
  ]]
  [[
```

| | |
|---|---|
| pathlossReferenceRsIdList-r18 | SEQUENCE{SIZE(1,...,MAX_PATHLOSS_RS_PER_TCI)} |
| of PUSCH-PathlossReferenceRS-Id | OPTIONAL, -- Cond |

```
JointTCI
  ul-powerControlList-r18
SEQUENCE{SIZE(1,...,MAX_POWER_CONTRL_SET_PER_TCI)} of Uplink-powerControlId-r17
OPTIONAL -- Cond JointTCI
  ]]
}
```

| | |
|---|---|
| TCI-UL-State-r17 ::= | SEQUENCE { |
| tci-UL-State-Id-r17 | TCI-UL-State-Id-r17, |
| servingCellId-r17 | ServCellIndex |

OPTIONAL, -- Need R

| | |
|---|---|
| bwp-Id-r17 | BWP-Id |

OPTIONAL, -- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | |
|---|---|
| additionalPCI-r17 | AdditionalPCIIndex-r17 |

OPTIONAL, -- Need R

| | |
|---|---|
| ul-powerControl-r17 | Uplink-powerControlId-r17 |

OPTIONAL, -- Need R

| | |
|---|---|
| pathlossReferenceRS-Id-r17 | PUSCH-PathlossReferenceRS-Id-r17 |

```
OPTIONAL, -- Need R
  ...,
  [[
```

| | |
|---|---|
| pathlossReferenceRsIdList-r18 | SEQUENCE{SIZE(1,...,MAX_PATHLOSS_RS_PER TCI)} |
| of PUSCH-PathlossReferenceRS-Id | OPTIONAL, |

```
  ul-powerControlList-r18
SEQUENCE{SIZE(1,...,MAX_POWER_CONTRL_SET_PER_TCI)} of Uplink-powerControlId-r17
OPTIONAL
  ]]
}
```

In another example, the network entity 304 may provide an additional list of pathloss reference signal IDs and/or an additional list of uplink power control IDs. The addtionalPathlossReferenceRuIdList configures the pathloss reference signal(s) in addition to the pathloss reference signal provided by pathlossReferenceRS-Id. The additionalUlPowerControlList configures the uplink power control set(s) in addition to the uplink power control set provided by the ul-powerControl-r17. An example code of the RRC signaling for the additional list could be as follows:

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PUSCH-PathlossReferenceRS-Id |

OPTIONAL, -- Cond JointTCI

| | |
|---|---|
| ul-powerControl-r17 | Uplink-powerControlId-r17 |

```
OPTIONAL -- Cond JointTCI
  ]],
  [[
  addtionalPathlossReferenceRsIdList-r18.
SEQUENCE{SIZE(1,...,MAX_PATHLOSS_RS_PER_TCI)} of PUSCH-PathlossReferenceRS-Id
OPTIONAL, -- Cond JointTCI
  additionalUlPowerControlList-r18
SEQUENCE{SIZE(1,...,MAX_POWER_CONTRL_SET_PER_TCI)} of Uplink-powerControlId-r17
OPTIONAL -- Cond JointTCI
  ]]
}
```

| | |
|---|---|
| TCI-UL-State-r17 ::= | SEQUENCE { |
| tci-UL-State-Id-r17 | TCI-UL-State-Id-r17, |
| servingCellId-r17 | ServCellIndex |

OPTIONAL, -- Need R

| | |
|---|---|
| bwp-Id-r17 | BWP-Id |

OPTIONAL, -- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | |
|---|---|
| additionalPCI-r17 | AdditionalPCIIndex-r17 |

OPTIONAL, -- Need R

| | |
|---|---|
| ul-powerControl-r17 | Uplink-powerControlId-r17 |

OPTIONAL, -- Need R

| | |
|---|---|
| pathlossReferenceRS-Id-r17 | PUSCH-PathlossReferenceRS-Id-r17 |

```
OPTIONAL, -- Need R
  ...,
  [[
  addtionalPathlossReferenceRsIdList-r18
SEQUENCE{SIZE(1,...,MAX_PATHLOSS_RS_PER_TCI)} of PUSCH-PathlossReferenceRS-Id
OPTIONAL,
  additionalUlPowerControlList-r18
SEQUENCE{SIZE(1,...,MAX_POWER_CONTRL_SET_PER_TCI)} of Uplink-powerControlId-r17
OPTIONAL
  ]]
}
```

In some examples, the network entity 304 configures at least one power control parameter set and/or at least one pathloss reference signal for signal reception, and at least associated one power control parameter set and/or at least one pathloss reference signal for interference suppression. The network entity 304 uses the power control parameter set(s) or pathloss reference signal(s) for signal reception to control the transmission power so that the UE 302 could produce an uplink transmission with the receiving power spectrum close to the target receiving power spectrum for the target receiving TRP(s). The power control parameter set(s) or pathloss reference signal(s) for interference suppression are used to control the UE transmission power so that it could not produce an uplink transmission with the receiving power spectrum higher than the target receiving power spectrum for interference to neighbor TRPs.

FIG. 4C is a diagram 400c illustrating yet another example of a configuration of a plurality of power control parameter sets in the interference-aware uplink power control. In this example, the network entity 304 configures two lists of power control parameter sets. The first list of power control parameter sets includes one or more power control parameter sets for signal reception, which is the power control to reach a target receiving power at a target receiving TRP. The second list of power control parameter sets includes one or more power control parameter sets for interference suppression, which is the power control to reduce the interference at a victim TRP.

Referring to FIG. 4C, for example, the first list of power control parameter sets includes the power control parameter set 1 and set 2, and the UE 302 uses the first list of power control parameter sets for the power control to reach the target receiving power at the target receiving TRPs 304A, 304B. The second list of power control parameter sets includes the power control parameter set 3 and set 4, and the UE 302 uses the second list of power control parameter sets for the power control to reduce the interference at victim TRPs 304C, 304D.

In one example, the network entity 304 may provide a first list of pathloss reference signal IDs, and/or a first list of uplink power control IDs for signal reception, and a second list of pathloss reference signal IDs and/or a second list of uplink power control IDs for interference suppression. The code of the RRC signaling could be as follows.

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PUSCH-PathlossReferenceRS-Id |

OPTIONAL, -- Cond JointTCI

| | |
|---|---|
| ul-powerControl-r17 | Uplink-powerControlId-r17 |

```
OPTIONAL -- Cond JointTCI
  ]],
  [[
  pathlossReferenceRsIdListForSignal-r18
SEQUENCE{SIZE(1,...,MAX_PATHLOSS_RS_FOR_SIGNAL_PER_TCI)} of PUSCH-PathlossReferenceRS-
```

| | |
|---|---|
| Id | OPTIONAL, -- Cond JointTCI |

ul-powerControlListForSignal-r18
SEQUENCE{SIZE(1,...,MAX_POWER_CONTRL_SET_FOR_SIGNALPER_PER_TCI)} of Uplink-

| | |
|---|---|
| powerControlId-r17 | OPTIONAL, -- Cond JointTCI |

pathlossReferenceRsIdListForInterference-r18
SEQUENCE{SIZE(1,...,MAX_PATHLOSS_RS_FOR_INTERFERENCE_PER_TCI)} of PUSCH-

| | |
|---|---|
| PathlossReferenceRS-Id | OPTIONAL, -- Cond JointTCI |

ul-powerControlListForInterference-r18
SEQUENCE{SIZE(1,...,MAX_POWER_CONTROL_SET_FOR_INTERFERENCE_PER_TCI)} of Uplink-

| | |
|---|---|
| powerControlId-r17 | OPTIONAL, -- Cond JointTCI |

]]
}

| | |
|---|---|
| TCI-UL-State-r17 ::= | SEQUENCE { |
| tci-UL-State-Id-r17 | TCI-UL-State-Id-r17, |
| servingCellId-r17 | ServCellIndex |

OPTIONAL, -- Need R

| | |
|---|---|
| bwp-Id-r17 | BWP-Id |

OPTIONAL, -- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | |
|---|---|
| additionalPCI-r17 | AdditionalPCIIndex-r17 |

OPTIONAL, -- Need R

| | |
|---|---|
| ul-powerControl-r17 | Uplink-powerControlId-r17 |

OPTIONAL, -- Need R

| | |
|---|---|
| pathlossReferenceRS-Id-r17 | PUSCH-PathlossReferenceRS-Id-r17 |

```
OPTIONAL, -- Need R
  ...,
  [[
  pathlossReferenceRsIdListForSignal-r18
SEQUENCE{SIZE(1,...,MAX_PATHLOSS_RS_FOR_SIGNAL_PER_TCI)} of PUSCH-PathlossReferenceRS-
```

| | |
|---|---|
| Id | OPTIONAL, |

ul-powerControlListForSignal-r18
SEQUENCE{SIZE(1,...,MAX_POWER_CONTRL_SET_FOR_SIGNALPER_PER_TCI)} of Uplink-

| | |
|---|---|
| powerControlId-r17 | OPTIONAL |

pathlossReferenceRsIdListForInterference-r18
SEQUENCE{SIZE(1,...,MAX_PATHLOSS_RS_FOR_INTERFERENCE_PER_TCI)} of PUSCH-

| | |
|---|---|
| PathlossReferenceRS-Id | OPTIONAL, |

ul-powerControlListForInterference-r18
SEQUENCE{SIZE(1,...,MAX_POWER_CONTRL_SET_FOR_INTERFERENCE_PER_TCI)} of Uplink-

| | |
|---|---|
| powerControlId-r17 | OPTIONAL |

]]
}

Referring back to FIG. 3A, the network entity 304 transmits 308 a second control signal to trigger an uplink signal based on at least one of the multiple power control parameter sets. The network entity 304 triggers an uplink transmission, e.g. PUSCH/PUCCH/SRS, by the uplink signal with or without further down-selection of the multiple uplink power control parameter sets. In some examples, the network entity 304 selects the at least one of power control parameter sets, where the second control signal indicates the at least one of the plurality of power control parameter sets.

The network entity 304 may transmit a lower layer signaling, e.g., Medium Access Control (MAC) control element (CE) or downlink Control information (DCI), to further down-select the at least one power control parameter set from the multiple power control parameter sets, configured by RRC signaling. For example, for the triggered uplink signal, the one or more target receiving TRPs and victim TRPs for interference suppression could be different at different times. Then such dynamic power control set selection could be helpful to accommodate different cases. The second control signal indicates the at least one power control parameter set that is dynamically selected from the plurality of power control parameter sets according to different situations.

In some examples, if the network entity 304 configures a single list of power control parameter sets and/or pathloss reference signals, the network entity 304 can indicate the uplink power control set(s) selection (when ul-powerControlList or additionalUlPowerControlList is configured) or uplink pathloss reference signal(s) selection (when pathlossReferenceRsIdList or addtionalPathlossReferenceRsIdList is configured) by the DCI. A DCI field may be introduced for the DCI format used to trigger uplink transmission, e.g., DC format 0_1/0_2 for PUSCH/SRS triggering and DCI format 1_1/1_2 for SRS/PUCCH triggering.

As an example, the DCI field only selects one uplink power control parameter set or pathloss reference signal. Then the payload size for the DCI field could be ceil(N), where N indicates the number of configured uplink power control sets or the number of configured pathloss reference signal. The network entity 304 might determine to configure the UE 302 to receive the DCI field, if the UE 302 or the network entity 304 supports one uplink power control set or pathloss reference signal.

As another example, the DCI field selects more than one uplink power control parameter sets. The DCI field could be a N-bit bitmap, where bit x is used to indicate whether the uplink power control parameter set or pathloss reference signal x is selected or not. The network entity 304 might determine to configure the UE 302 to receive the DC field, if the UE 302 or the network entity 304 supports one uplink power control set or pathloss reference signal or more than one uplink power control set or pathloss reference signal.

For one example, if the network entity 304 configures two lists of power control parameter sets and/or pathloss reference signals, e.g., the first list for signal reception and the second list for interference suppression, the network entity 304 might indicate the uplink power control parameter set(s) selection or uplink pathloss reference signal(s) selection by the DCI. One or two DC fields may be introduced for separate or joint indication on the power control parameter set(s) selection for each list for the DCI format used to trigger the uplink transmission, e.g., DCI format 0_1/0_2 for PUSCH/SRS triggering and DCI format 1_1/1_2 for SRS/PUCCH triggering.

In some other examples, the network entity 304 might indicate the uplink power control parameter set(s) selection or uplink pathloss reference signal(s) selection by the MAC CE. In one example, the MAC CE is a dedicated MAC CE for power control parameter set(s) or pathloss reference signal(s) selection. The MAC CE may at least include one of the following elements: serving cell index, bandwidth part index, selected power control parameter set(s), or selected pathloss reference signal(s). In another example, the MAC CE is the MAC CE used for TC activation, where a new field can be introduced to indicate the selected power control parameter set(s) and/or pathloss reference signal(s).

In some examples, the network entity 304 might configure or indicate a first set of TC states for signal reception for an uplink channel, e.g., PUSCH, PUCCH or SRS, by RRC signaling or MAC CE. The network entity 304 might further down-select one TCI or a subset of TCI states from the configured first set of TCI states by DCI that schedules the uplink channel. Each TC state includes a pathloss reference signal and a power control parameter set. The UE 302 can identify the pathloss reference signal(s) and power control parameter set(s) for uplink power control for signal reception with the indicated TCI state(s) from the first set of TC states. The network entity 304 might further configure or indicate a second set of TCI states for interference suppression by RRC signaling or MAC CE. The network entity 304 might further down-select one TCI or a subset of TCI states for interference suppression from the configured second set of TC states by DCI that schedules the uplink channel. The UE 302 can identify the pathloss reference signal(s) and power control parameter set(s) for uplink power control for interference suppression with the indicated TCI state(s) from the second set of TCI states.

Responsive to receiving 308 the second control signal, the UE 302 might determine 312 the transmission power for the transmission occasion of the uplink channel/signal based on the selected at least one of the configured/indicated power control parameter sets and/or pathloss reference signals. In some examples, if a single list of power control parameter sets and/or pathloss reference signals is configured, the UE 302 might determine multiple target transmission powers. Each of the multiple target transmission powers is based on one power control parameter set and/or pathloss reference signal. Then the UE may determine the transmission power based on the minimal/maximum/average power of the multiple target transmission powers. A reference to the minimal power of the multiple target transmission powers can also correspond to a minimum power of the multiple target transmission powers that are determined by the UE. As an example, the target transmission power for a transmission occasion i for power control parameter set k or pathloss reference signal k might be determined as follows:

$${P}_{Tx , k} ( i ) = min \{ {P}_{CMAX} ( i ) , {P}_{0 , k} + {α}_{k} \times P {L}_{k} + {Δ}_{BW} + {Δ}_{TF} + {f}_{k} ( i ) \} ,$$

wherein P_{CMAX}(i) indicates a maximum transmission power at the transmission occasion i; P_{0,k} is a target receiving power spectrum density for a power control parameter set k; αₖ is a fractional power control factor for the power control parameter set k; Δ_{BW} is a bandwidth factor; Δ_{TF} is a transmission format (TF) factor; fₖ(i) is a closed-loop power control factor for the power control parameter set k; PLₖ is a pathloss measured based on a pathloss reference signal for the power control parameter set k. As another example, the target transmission power for the transmission occasion i for power control parameter set k might be determined as:

$${P}_{Tx , k} ( i ) = {P}_{0 , k} + {α}_{k} \times P {L}_{k} + {Δ}_{BW} + {Δ}_{TF} + {f}_{k} ( i )$$

wherein P_{0,k} is a target receiving power spectrum density for a power control parameter set k; αₖ is a fractional power control factor for the power control parameter set k: Δ_{BW} is a bandwidth factor: Δ_{TF} is a transmission format (TF) factor; fₖ(i) is a closed-loop power control factor for the power control parameter set k; PLₖ is a pathloss measured based on a pathloss reference signal for the power control parameter set k.

The transmission power for the transmission occasion i for the uplink signal is determined as:

$${P}_{Tx} ( i ) = min \{ {P}_{CMAX} ( i ) , {\hat{P}}_{Tx} ( i ) \} ,$$

where P̌_{Tx}(i) is calculated as follows:

$${\hat{P}}_{Tx} ( i ) = min \{ {P}_{Tx , 1} ( i ) , ... , {P}_{Tx , K} ( i ) \} ,$$

$$or$$

$${\hat{P}}_{Tx} ( i ) = \{ {P}_{Tx , 1} ( i ) , ... , {P}_{Tx , K} ( i ) \} ,$$

$$or$$

$${\hat{P}}_{Tx} ( i ) = \frac{1}{K} {\sum }_{k = 1}^{K} {P}_{Tx , k} ( i ) ,$$

$$or$$

$${\hat{P}}_{Tx} ( i ) = {\sum }_{k = 1}^{K} {β}_{k} {P}_{Tx , k} ( i ) ,$$

where K indicates the number of the at least one selected power control parameter of the multiple power control parameter sets or pathloss reference signals: βₖ indicates a scaling factor for power control set k or pathloss reference signal k, which can be predefined or configured by the network entity 304 by RRC signaling. In some implementation, the network entity 304 may indicate the transmission power calculation scheme by higher layer signaling, e.g., RRC signaling or MAC CE, or DCI.

For pathloss measurement, if more than one pathloss reference signals are associated with the indicated unified TCI state, the UE 302 might apply the same spatial receiving parameters, e.g., the same receiving beam(s), to receive these pathloss reference signals for pathloss estimation. In one example, the network entity 304 provides the same quasi-co-location (QCL) typed (spatial receiving parameters) indication for the pathloss reference signals. In another example, the QCL-TypeD property for these pathloss reference signals might be based on one of the pathloss reference signals, e.g., the one configured in the first power control parameter set.

In some other examples, if the network entity 304 configures a first list of one or more power control parameter sets and/or pathloss reference signals for signal reception and a second list of one or more power control parameter sets and/or pathloss reference signals for interference suppression, the UE 302 might determine multiple target transmission power. Each target transmission power is based on one power control parameter set and/or pathloss reference signal. Then the UE 302 might determine (or derive) a first transmission power based on the target transmission powers from the one or more power control parameter sets for signal reception and determine (or derive) a second transmission power based on the target transmission powers from the one or more power control parameter sets for interference suppression. Next, the UE 302 might determine the transmission power for the uplink signal based on the determined first and second transmission power.

Similarly as discussed above, the target transmission power for transmission occasion i for power control parameter set k or pathloss reference signal k can be determined as follows:

$${P}_{Tx , k} ( i ) = min \{ {P}_{CMAX} ( i ) , {P}_{0 , k} + {α}_{k} \times P {L}_{k} + {Δ}_{BW} + {Δ}_{TF} + {f}_{k} ( i ) \} ,$$

$$or$$

$${P}_{Tx , k} ( i ) = {P}_{0 , k} + {α}_{k} \times P {L}_{k} + {Δ}_{BW} + {Δ}_{TF} + {f}_{k} ( i ) .$$

Then the first transmission power for signal reception can be calculated as follows:

$${P}_{Tx}^{( 1 )} ( i ) = min \{ {P}_{Tx , {s}_{1}} ( i ) , ... , {P}_{Tx , {s}_{{K}_{1}}} ( i ) \} ,$$

$$or$$

$${P}_{Tx}^{( 1 )} ( i ) = \{ {P}_{Tx , {s}_{1}} ( i ) , ... , {P}_{Tx , {s}_{{K}_{1}}} ( i ) \} ,$$

$$or$$

$${P}_{Tx}^{( 1 )} ( i ) = \frac{1}{{K}_{1}} {\sum }_{k ϵ {S}_{1}} {P}_{Tx , k} ( i ) ,$$

$$or$$

$${P}_{Tx}^{( 1 )} ( i ) = {\sum }_{k ϵ {S}_{1}} {β}_{k} {P}_{Tx , k} ( i ) ,$$

$${\sum }_{k ϵ {S}_{1}} {β}_{k} = 1 ,$$

where K₁ indicates the number of the selected at least one of power control parameter sets or pathloss reference signals for signal reception; S₁ indicates the power control parameter sets or pathloss reference signals for signal reception, and s₁, s₂, . . . , S_{K}_{₁}∈S₁; βₖ indicates a scaling factor for power control set k or pathloss reference signal k, which can be predefined or configured by the network entity 304 by RRC signaling. In some examples, the network entity 304 might indicate the transmission power calculation scheme for the first transmission power calculation by higher layer signaling, e.g., RRC signaling or MAC CE, or DCI.

The second transmission power for interference suppression can be calculated as follows:

$${P}_{Tx}^{( 2 )} ( i ) = min \{ {P}_{Tx , {d}_{1}} ( i ) , … , {P}_{Tx , {d}_{{K}_{2}}} ( i ) \} ,$$

$$or$$

$${P}_{Tx}^{( 2 )} ( i ) = \frac{1}{{K}_{2}} {\sum }_{k ∈ {S}_{2}} {P}_{Tx , k} ( i ) ,$$

$$or$$

$${P}_{Tx}^{( 2 )} ( i ) = {\sum }_{k ∈ {S}_{2}} {γ}_{k} {P}_{Tx , k} ( i ) ,$$

$${\sum }_{k ∈ {S}_{2}} {γ}_{k} = 1 ,$$

where K₂ indicates the number of the selected at least one of power control parameter sets or pathloss reference signals for interference suppression; S₂ indicates the power control parameter sets or pathloss reference signals for interference suppression, and d₁, d₂, . . . , d_{K}_{₂}∈S₂; γₖ indicates a scaling factor for power control set k or pathloss reference signal k, which can be predefined or configured by the network entity 304 by RRC signaling. In some examples, the network entity 304 might indicate the transmission power calculation scheme for the second transmission power calculation by higher layer signaling, e.g., RRC signaling or MAC CE, or DCI.

The transmission power for transmission occasion i for the uplink signal based on the first transmission power for signal reception and the second transmission power for interference suppression might be determined as follows:

$${P}_{Tx} ( i ) = min \{ {P}_{CMAX} ( i ) , {\hat{P}}_{Tx} ( i ) \} ,$$

where P̌_{Tx}(i) is calculated as follow:

$${\hat{P}}_{Tx} ( i ) = min \{ {P}_{Tx}^{( 1 )} ( i ) , {P}_{Tx}^{( 2 )} ( i ) \} ,$$

$$or$$

$${\hat{P}}_{Tx} ( i ) = τ \times {P}_{Tx}^{( 1 )} ( i ) + ( 1 - τ ) {P}_{Tx}^{( 2 )} ( i ) ,$$

where τ is in the range of(0, 1), which can be predefined, e.g., τ=0.5, or be configured by the network entity 304 by higher layer signaling, e.g., RRC signaling or MAC CE, or DCI. In some examples, the network entity 304 might indicate the transmission power calculation scheme for the transmission power calculation by higher layer signaling, e.g., RRC signaling or MAC CE, or DCI.

In some examples, for pathloss measurement, if more than one pathloss reference signals are associated with the indicated unified TC state, the UE 302 might apply the same spatial receiving parameters, e.g., the same receiving beam(s), to receive these pathloss reference signals for pathloss estimation. In one example, the network entity 304 provides the same quasi-co-location (QCL) typed (spatial receiving parameters) indication for the pathloss reference signals. In another example, the QCL-TypeD property for these pathloss reference signals might be based on one of the pathloss reference signals, e.g., the one configured in the first power control parameter set.

After determining the transmission power as discussed above, the UE 302 transmits 314 the uplink signal based on the determined transmission power. The interference-aware uplink power control includes multiple uplink power control parameter sets. When the UE determines the transmission power for an uplink signal toward one TRP, it controls the interference to other TRPs as directed by the uplink power control parameter sets. In addition, if the uplink signal is toward multiple TRPs, the UE determines a proper transmission power with regard to different pathloss statuses between the UE and different target receiving TRPs.

The UE 302 might transmit 316 a PHR based on the selected at least one of power control parameter sets. For example, the UE 302 might determine the PH based on the selected power control parameter set(s) and/or pathloss reference signal(s). As discussed above, the network entity 304 might indicate the selected power control parameter set(s) and/or pathloss reference signal(s) from the configured selected power control parameter set(s) and/or pathloss reference signal(s), which might be associated with the indicated unified TCI state for PUSCH/SRS by higher layer signaling, e.g., RRC signaling or MAC CE, or DCI.

In some examples, the actual PH can be calculated based on the maximum transmission power for the transmission occasion and the transmission power derived from the selected power control parameter set(s) and/or pathloss reference signal(s). In one example, the actual PH can be calculated as follows:

$$PH ( i ) = {P}_{CMAX} ( i ) - {\hat{P}}_{Tx} ( i ) .$$

In another example, if the two lists of power control parameter sets are configured, the actual PH can be calculated as follows:

$$PH ( i ) = {P}_{CMAX} ( i ) - {\hat{P}}_{Tx} ( i ) ,$$

$$or$$

$$PH ( i ) = {P}_{CMAX} ( i ) - {P}_{Tx}^{( 1 )} ( i ) .$$

In some examples, the reference PH can be calculated based on the reference maximum transmission power and one of the selected power control parameter sets and pathloss reference signals. In one example, the first selected power control parameter set and the first configured pathloss reference signal might be used for reference PH calculation. In another example, the network entity 304 might indicate the index of the power control parameter set and pathloss reference signal used for reference PH calculation by higher layer signaling, e.g., RRC signaling or MAC CE, or DCI.

In some other examples, the reference PH can be calculated based on the reference maximum transmission power and the selected power control parameter sets and pathloss reference signals. The UE 302 might determine multiple reference target transmission power, where each reference target transmission power is based on one power control parameter set and/or pathloss reference signal. Then the UE 302 might determine the reference PH based on the minimal (e.g., minimum), the maximum, or the average power of the multiple reference target transmission power. The reference target transmission power for transmission occasion i for power control parameter set k or pathloss reference signal k can be determined as follows:

$${\tilde{P}}_{Tx , k} ( i ) = min \{ {\tilde{P}}_{CMAX} ( i ) , {P}_{0 , k} + {α}_{k} \times {PL}_{k} + {f}_{k} ( i ) \} ,$$

$$or$$

$${\tilde{P}}_{Tx , k} ( i ) = {P}_{0 , k} + {α}_{k} \times {PL}_{k} + {f}_{k} ( i ) .$$

In one example, if one list of power control parameter sets is configured, the reference PH can be calculated as follows:

$$( i ) = {\tilde{P}}_{CMAX} ( i ) - min \{ {\tilde{P}}_{T x . 1} ( i ) , … , {\tilde{P}}_{Tx , K} ( i ) \} ,$$

$$or$$

$$( i ) = {\tilde{P}}_{CMAX} ( i ) - max \{ {\tilde{P}}_{Tx , 1} ( i ) , … , {\tilde{P}}_{Tx , K} ( i ) \} ,$$

$$or$$

$$( i ) = {\tilde{P}}_{CMAX} ( i ) - \frac{1}{K} {\sum }_{k = 1}^{K} {\tilde{P}}_{Tx , k} ( i ) ,$$

$$or$$

$$( i ) = {\tilde{P}}_{CMAX} ( i ) - {\sum }_{k = 1}^{K} {β}_{k} {\tilde{P}}_{Tx , k} ( i ) .$$

The network entity 304 might further indicate the scheme (the selected equation from above) for the reference PH calculation by higher layer signaling, e.g., RRC signaling or MAC CE, or DCI.

In another example, if the network entity 304 configures two lists of power control parameter sets, the reference PH can be calculated based on the first list used for power control for signal reception. The detailed calculation operation is the same as the previous example where only the power control parameter sets in the first list are used for the calculation.

In another example, if the network entity 304 configures two lists of power control parameter sets, the reference PH can be calculated as follows:

$$( i ) = {\tilde{P}}_{CMAX} ( i ) - min \{ {\tilde{P}}_{Tx}^{( 1 )} ( i ) , {\tilde{P}}_{Tx}^{( 2 )} ( i ) \} ,$$

$$or$$

$$( i ) = {\tilde{P}}_{CMAX} ( i ) - \{ τ \times {\tilde{P}}_{Tx}^{( 1 )} ( i ) + ( 1 - τ ) {\tilde{P}}_{Tx}^{( 2 )} ( i ) \} ,$$

$$or$$

$$( i ) = {\tilde{P}}_{CMAX} ( i ) - {\tilde{P}}_{Tx}^{( 1 )} ( i ) ,$$

where

$${\tilde{P}}_{T x}^{( 1 )} ( i ) and {\tilde{P}}_{Tx}^{( 2 )} ( i )$$

are derived based on the equation for

$${P}_{T x}^{( 1 )} ( i ) and {P}_{Tx}^{( 2 )} ( i )$$

by replacing P_{Tx,k}(i) into \tilde{P}_{Tx,k}(i). The network entity 304 might further indicate the scheme (the selected equation from above) for the reference PH calculation by higher layer signaling, e.g., RRC signaling or MAC CE, or DCI.

In some examples, if more than one pathloss reference signals are associated with an indicated unified TCI, whether the UE 302 can trigger a PHR or not can be determined by at least one of the pathloss reference signals and pathloss change threshold.

As an example, the UE 302 can trigger the PHR (e.g., the UE 302 can transmit the PHR by MAC CE or transmit a scheduling request (SR) to request uplink resource for the PHR), if the PHR prohibit timer, e.g., phr-ProhibitTimer, expires or has expired and the pathloss has changed more than a configured threshold, e.g., phr-Tx-PowerFactorChange dB, for at least one RS used as the first pathloss reference for one activated serving cell of any MAC entity of which the active downlink BWP is not dormant BWP since the last transmission of the PHR in this MAC entity when the MAC entity has uplink resources for new transmission.

As another example, the UE 302 can trigger the PHR (e.g., the UE 302 can transmit the PHR by MAC CE or transmit an SR to request uplink resource for the PHR), if the PHR prohibit timer, e.g. phr-ProhibitTimer, expires or has expired and the minimum/, the maximum, or the average pathloss has changed more than a configured threshold, e.g., phr-Tx-PowerFactorChange dB, for at least one RS used as pathloss reference for one activated serving cell of any MAC entity of which the active downlink BWP is not dormant BWP since the last transmission of the PHR in this MAC entity when the MAC entity has uplink resources for new transmission.

As yet another example, the UE 302 can trigger the PHR (e.g., the UE 302 can transmit the PHR by MAC CE or transmit an SR to request uplink resource for the PHR), if the PHR prohibit timer, e.g., phr-ProhibitTimer, expires or has expired and the pathloss has changed more than a configured threshold, e.g., phr-Tr-PowerFactorChange dB, for at least one RS used as pathloss reference for signal reception for one activated serving cell of any MAC entity of which the active downlink BWP is not dormant BWP since the last transmission of the PHR in this MAC entity when the MAC entity has uplink resources for new transmission.

In this way, the UE 302 transmits 314 the uplink signal with the transmission power determined based on the selected at least one of the multiple uplink power control parameter sets in the interference-aware uplink power control, which controls the interference to other TRPs as directed by the multiple uplink power control parameter sets. Moreover, if the uplink signal is toward multiple TRPs, the UE determines the proper transmission power with regard to different pathloss statuses between the UE and different target receiving TRPs. The UE 302 further transmits 316 the PHR including the actual PH and/or the reference PH based on the selected at least one of the multiple uplink power control parameter sets. The procedure for the interference-aware uplink power control for the network entity 304 and the UE 302 is discussed as above. In some situations, the UE 302 is in a dual-connectivity (DC) mode. The procedure for the interference-aware uplink power control for the UE 302 in the DC mode will be discussed below in connection with FIGS. 3A-3B.

FIG. 3B illustrates a signaling diagram 300b of an example for an interference-aware uplink power control procedure for the UE 302 in the DC mode. In the DC mode, the UE 302 is connected to one network entity that acts as a master node (MN) 304A and one network entity that acts as a secondary node (SN) 304B. In some examples, the UE 302 may transmit 305a the UE capability message regarding interference-aware uplink power control to the MN 304A, and the MN 304A can forward the UE capability message to the SN 304B. The SN 304B may directly transmit the control signaling for interference-aware power control to the UE. The SN 304B may transmit 306 a first control signal to the UE 302 to provide the multiple uplink power control parameter sets for the uplink channel or resource. The SN 304B may transmit 308 a second control signal to trigger an uplink signal based on at least one of the multiple power control parameter sets. Similar to FIG. 3, the UE 302 may determine 312 the transmission power for the triggered uplink signal based on the selected at least one of power control parameter sets. Afterwards, the UE 302 transmits 314 the uplink signal to the SN 304B based on the determined transmission power. The UE 302 might transmit 316 a PHR to the SN 304B based on the selected at least one of power control parameter sets. Details for each operation are provided below.

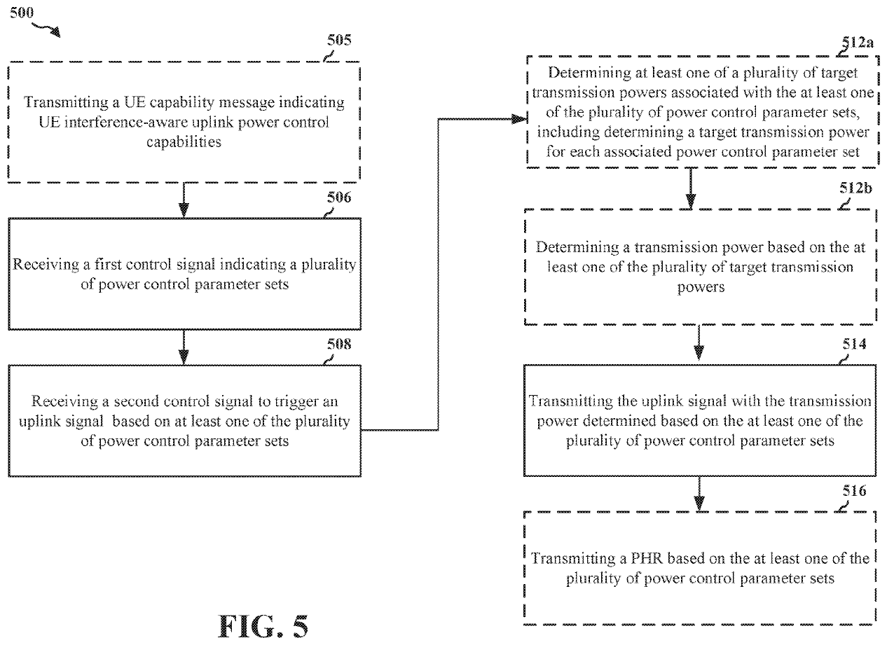

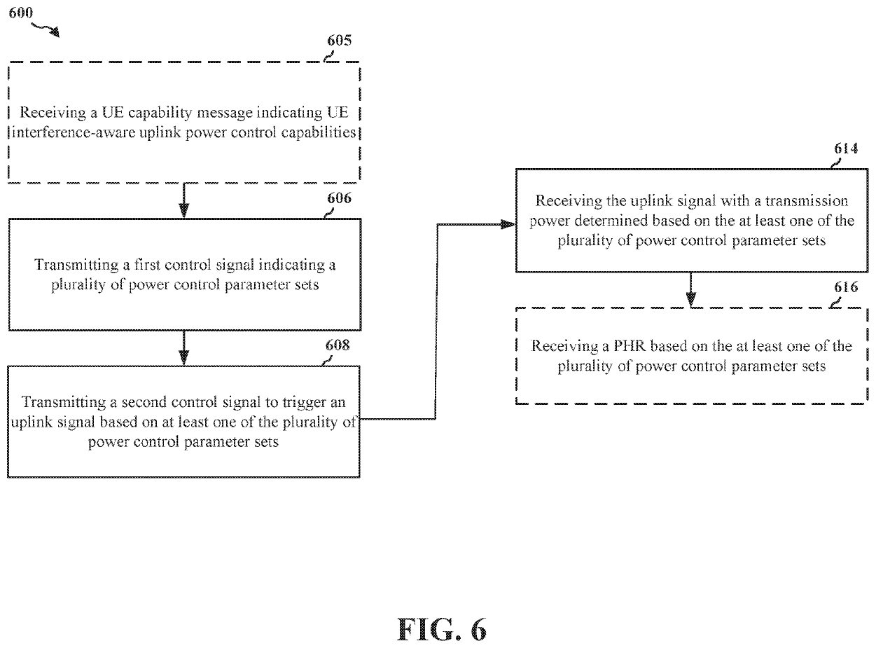

FIG. 3C illustrates a signaling diagram 300c of another example for an interference-aware uplink power control procedure for the UE 302 in the DC mode. Different than in FIG. 3B, the SN 304B may transmit the control signaling for interference-aware power control to the MN 304A, and the MN 304A may transmit the corresponding control signaling to the UE. Referring to FIG. 3C, the SN 304B may transmit 306a a first control signal to the UE 302 to provide the multiple uplink power control parameter sets for the uplink channel or resource, and the MN 304A may transmit the first control signal to the UE 302. The SN 304B may transmit 306b a second control signal to trigger an uplink signal based on at least one of the multiple power control parameter sets. FIGS. 5-6 show methods for implementing one or more aspects of FIGS. 3A-3C, 4A-4C. In particular, FIG. 5 shows an implementation by the UE 302 of the one or more aspects of FIGS. 3A-3C, 4A-4C. FIG. 6 shows an implementation by the network entity 304 of the one or more aspects of FIGS. 3A-3C, 4A-4C.

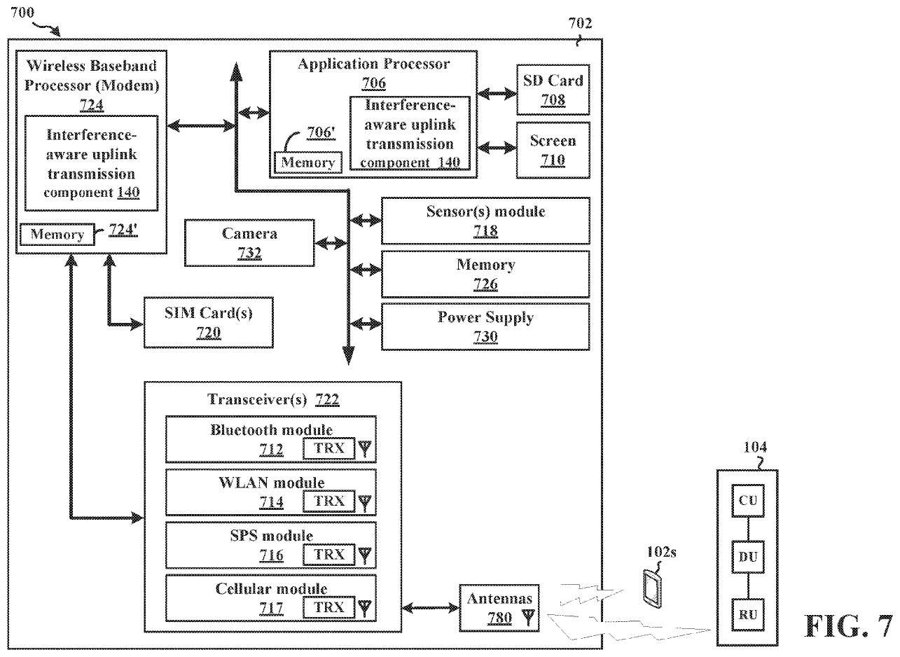

FIG. 5 illustrates a flowchart 500 of a method of interference-aware uplink power control at a UE. With reference to FIGS. 1 and 7, the method may be performed by the UE 102, the UE 302, the UE apparatus 702, etc., which may include the memory 724′ and which may correspond to the entire UE 102, UE 302 or the UE apparatus 702, or a component of the UE 102, UE 302 or the UE apparatus 702, such as the wireless baseband processor 724, and/or the application processor 706.

The UE (e.g., 102, 302, 702) might transmit 505 a UE capability message indicating UE interference-aware uplink power control capabilities. For example, referring to FIG. 3A, the UE 302 transmits 305 the UE capability message to the network entity 304.

The UE (e.g., 102, 302, 702) receives 506 a first control signal indicating a plurality of power control parameter sets, where the plurality of power control parameter sets is configured based on the UE interference-aware uplink power control capabilities. For example, referring to FIG. 3A, the UE 302 receives 306 the first control signal indicating a plurality of power control parameter sets from the network entity 304.

The UE (e.g., 102, 302, 702) receives 508 a second control signal to trigger an uplink signal based on at least one of the plurality of power control parameter sets. For example, referring to FIG. 3A, the UE 302 receives 308 a second control signal to trigger an uplink signal based on at least one of the plurality of power control parameter sets from the network entity 304.

The UE (e.g., 102, 302, 702) might determine 512a at least one of a plurality of target transmission powers associated with the at least one of the plurality of power control parameter sets, where the UE 302 might determine a target transmission power for each associated power control parameter set. The UE 302 might determine 512b a transmission power based on the at least one of the plurality of target transmission powers. For example, referring to FIG. 3A, the UE 302 determines 312 the transmission power for the triggered uplink signal.

The UE (e.g., 102, 302, 702) transmits 514 the uplink signal with the transmission power determined based on the at least one of the plurality of power control parameter sets. For example, referring to FIG. 3A, the UE 302 transmits 314 the triggered uplink signal with the determined transmission power.

The UE (e.g., 102, 302, 702) might transmit 516 a PHR based on the at least one of the plurality of power control parameter sets. For example, referring to FIG. 3A, the UE 302 transmits 316 the PHR based on the at least one of the plurality of power control parameter sets. FIG. 5 describes a method from a UE-side of a wireless communication link, whereas FIG. 6 describes a method from a network-side of the wireless communication link.

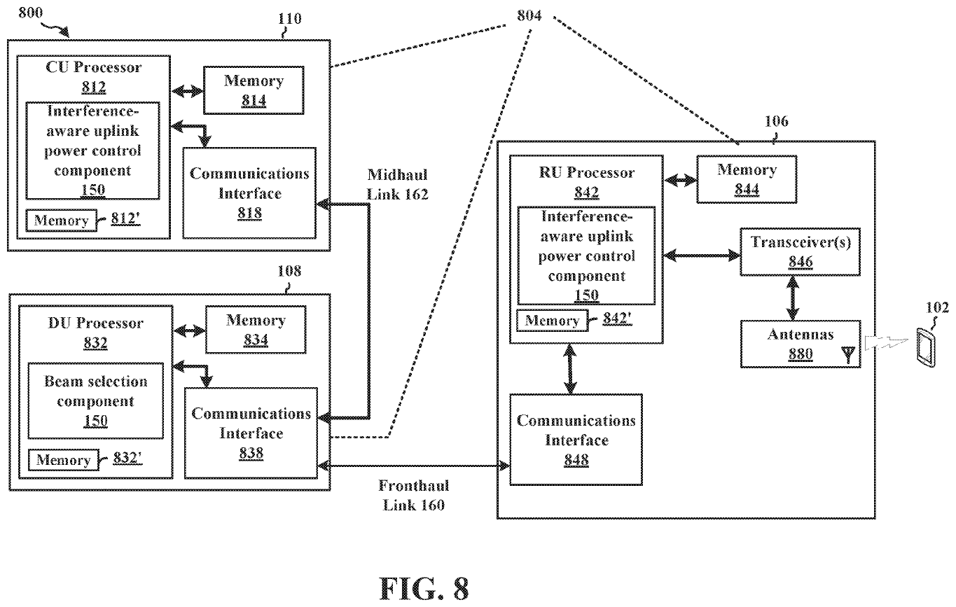

FIG. 6 is a flowchart 600 of a method of interference-aware uplink power control at a network entity. With reference to FIGS. 1 and 8, the method may be performed by the base station 104, or the network entity 304, or one or more network entities 804 at the base station 104, which may correspond to the RU 106, the DU 108, the CU 110, an RU processor 842, a DU processor 832, a CU processor 812, etc. The base station 104, the network entity 304, or the one or more network entities 804 at the base station 104 may include the memory 812′/832′/842′, which may correspond to an entirety of the one or more network entities 804 or the base station 104, or the network entity 304, or a component of the one or more network entities 804 or the base station 104, or the network entity 304, such as the RU processor 842, the DU processor 832, or the CU processor 812.

The network entity (e.g., 104, 304, 804) might receive 605 a UE capability message indicating UE interference-aware uplink power control capabilities. For example, referring to FIG. 3A, the network entity 304 receives 305 the UE capability message from the UE 302.

The network entity (e.g., 104, 304, 804) transmits 606 a first control signal indicating a plurality of power control parameter sets, where the plurality of power control parameter sets is configured based on the UE interference-aware uplink power control capabilities. For example, referring to FIG. 3A, the network entity 304 transmits 306 the first control signal indicating a plurality of power control parameter sets to the UE 302.

The network entity (e.g., 104, 304, 804) transmits 608 a second control signal to trigger an uplink signal based on at least one of the plurality of power control parameter sets. For example, referring to FIG. 3A, the network entity 304 transmits 308 a second control signal to trigger an uplink signal based on at least one of the plurality of power control parameter sets to the UE 302.

The network entity (e.g., 104, 304, 804) receives 614 the uplink signal with the transmission power determined based on the at least one of the plurality of power control parameter sets. For example, referring to FIG. 3A, the network entity 304 receives 314 the triggered uplink signal with the determined transmission power from the UE 302.

The network entity (e.g., 104, 304, 804) might receive 616 a PHR based on the at least one of the plurality of power control parameter sets. For example, referring to FIG. 3A, the network entity 304 receives 316 the PHR based on the at least one of the plurality of power control parameter sets. A UE apparatus 702, as described in FIG. 7, may perform the method of flowchart 500. The base station 104, or the network entity 304, or the one or more network entities 804 at the base station 104, as described in FIG. 8, may perform the method of flowchart 600.

FIG. 7 is a diagram 700 illustrating an example of a hardware implementation for a UE apparatus 702. The apparatus 702 may be the UE 102, the UE 302, a component of the UE 102, the UE 302, or may implement UE functionality. In some aspects, the apparatus 702 may include a wireless baseband processor 724 (also referred to as a modem) coupled to one or more transceivers 722 (e.g., wireless RF transceiver). The wireless baseband processor 724 may include on-chip memory 724′. In some aspects, the apparatus 702 may further include one or more subscriber identity modules (SIM) cards 720 and an application processor 706 coupled to a secure digital (SD) card 708 and a screen 710. The application processor 706 may include on-chip memory 706′.

The apparatus 702 may further include a Bluetooth module 712, a WLAN module 714, an SPS module 716 (e.g., GNSS module), and a cellular module 717 within the one or more transceivers 722. The Bluetooth module 712, the WLAN module 714, the SPS module 716, and the cellular module 717 may include an on-chip transceiver (TRX) (or in some cases, just a receiver (RX)). The Bluetooth module 712, the WLAN module 714, the SPS module 716, and the cellular module 717 may include their own dedicated antennas and/or utilize the antennas 780 for communication. The apparatus 702 may further include one or more sensor modules 718 (e.g., barometric pressure sensor/altimeter: motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 726, a power supply 730, and/or a camera 732.

The wireless baseband processor 724 communicates through the transceiver(s) 722 via one or more antennas 780 with another UE 102 and/or with an RU associated with a base station 104, or a network entity 304. The wireless baseband processor 724 and the application processor 706 may each include a computer-readable medium/memory 724′, 706′, respectively. The additional modules of memory 726 may also be considered a computer-readable medium/memory. Each computer-readable medium/memory 724′, 706′, 726 may be non-transitory. The wireless baseband processor 724 and the application processor 706 are each responsible for general processing, including the execution of software stored on the computer-readable medium/memory. The software, when executed by the wireless baseband processor 724/application processor 706, causes the wireless baseband processor 724/application processor 706 to perform the various functions described. The computer-readable medium/memory may also be used for storing data that is manipulated by the wireless baseband processor 724/application processor 706 when executing software. The wireless baseband processor 724/application processor 706 may be a component of the UE 102. The apparatus 702 may be a processor chip (modem and/or application) and include just the wireless baseband processor 724 and/or the application processor 706, and in another configuration, the apparatus 702 may be the entire UE 102 and include the additional modules of the apparatus 702.

As discussed, the interference-aware uplink transmission component 140 is configured to receive a first control signal indicating a plurality of power control parameter sets, and to receive a second control signal to trigger an uplink signal based on at least one of the plurality of power control parameter sets. The interference-aware uplink transmission component 140 is further configured to transmit the uplink signal with a transmission power determined based on the at least one of the plurality of power control parameter sets. The interference-aware uplink transmission component 140 may be within the wireless baseband processor 724, the application processor 706, or both the wireless baseband processor 724 and the application processor 706. The interference-aware uplink transmission component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 702 may include a variety of components configured for various functions. In one configuration, the apparatus 702, and in particular the wireless baseband processor 724 and/or the application processor 706, includes means for receiving a first control signal indicating a plurality of power control parameter sets; means for receiving a second control signal to trigger an uplink signal based on at least one of the plurality of power control parameter sets; and means for transmitting the uplink signal with a transmission power determined based on the at least one of the plurality of power control parameter sets. The apparatus 702 further includes means for transmitting a UE capability message indicating UE interference-aware uplink power control capabilities. The apparatus 702 further includes means for determining at least one of a plurality of target transmission powers associated with the at least one of the plurality of power control parameter sets, including determining a target transmission power for each associated power control parameter set. The apparatus 702 further includes means for determining the transmission power based on the at least one of the plurality of target transmission powers; and means for transmitting a PHR. The means may be the interference-aware uplink transmission component 140 of the apparatus 702 configured to perform the functions recited by the means.

FIG. 8 is a diagram 800 illustrating an example of a hardware implementation for one or more network entities 804. The one or more network entities 804 may be a base station, a component of the base station, or may implement base station functionality. The one or more network entities 804 may include at least one of a CU 110, a DU 108, or an RU 106. For example, the interference-aware uplink power control component 150 may sit at one or more network entities 804 such as the CU 110; both the CU 110 and the DU 108; each of the CU 110, the DU 108, and the RU 106; the DU 108; both the DU 108 and the RU 106; or the RU 106.

The CU 110 may include a CU processor 812. The CU processor 812 may include on-chip memory 812′. In some aspects, the CU 110 may further include additional memory modules 814 and a communications interface 818. The CU 110 communicates with the DU 108 through a midhaul link 162, such as an F1 interface. The DU 108 may include a DU processor 832. The DU processor 832 may include on-chip memory 832′. In some aspects, the DU 108 may further include additional memory modules 834 and a communications interface 838. The DU 108 communicates with the RU 106 through a fronthaul link 160. The RU 106 may include an RU processor 842. The RU processor 842 may include on-chip memory 842′. In some aspects, the RU 106 may further include additional memory modules 844, one or more transceivers 846, antennas 880, and a communications interface 848. The RU 106 communicates wirelessly with the UE 102.

The on-chip memory 812′, 832′, 842′ and the additional memory modules 814, 834, 844 may each be considered a computer-readable medium/memory. Each computer-readable medium/memory may be non-transitory. Each of the processors 812, 832, 842 is responsible for general processing, including the execution of software stored on the computer-readable medium/memory. The software, when executed by the corresponding processor(s) causes the processor(s) to perform the various described functions. The computer-readable medium/memory may also be used for storing data that is manipulated by the processor(s) when executing software.

As discussed, the interference-aware uplink power control component 150 is configured to transmit a first control signal indicating a plurality of power control parameter sets, and to transmit a second control signal to trigger an uplink signal based on at least one of the plurality of power control parameter sets. The interference-aware uplink power control component 150 is further configured to receive the uplink signal with a transmission power determined based on at least one of the plurality of power control parameter sets. The interference-aware uplink power control component 150 may be within one or more processors of one or more of the CU 110, DU 108, and the RU 106. The interference-aware uplink power control component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 804 may include a variety of components configured for various functions. In one configuration, the one or more network entities 804 includes means for selecting one or more candidate beams for communication with a UE based on a prediction that the one or more candidate beams have an improved beam quality over a current beam quality of one or more current serving beams; means for transmitting, to the UE based on the prediction for the one or more candidate beams, beam indication signaling indicative of a selected beam from the one or more candidate beams; and means for communicating with the UE over the one or more candidate beams or the one or more current serving beams based on whether a first measurement of the one or more candidate beams and a second measurement of the one or more current serving beams indicates that the one or more candidate beams have the improved beam quality over the current beam quality of the one or more current serving beams.

The one or more network entities 804 further includes means for transmitting a first control signal indicating a plurality of power control parameter sets; means for transmitting a second control signal to trigger an uplink signal based on at least one of the plurality of power control parameter sets; and means for receiving the uplink signal with a transmission power determined based on at least one of the plurality of power control parameter sets. The means may be the interference-aware uplink power control component 150 of the one or more network entities 804 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Optional blocks of the processes and flowcharts may be indicated by dashed lines. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A. B, and/or C, such as A and B, A and C, B and C, or A and B and C, and may include multiples of A, multiples of B, and/or multiples of C. or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follow each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication by a UE, including: receiving a first control signal indicating a plurality of power control parameter sets; receiving a second control signal to trigger an uplink signal based on at least one of the plurality of power control parameter sets; and transmitting the uplink signal with a transmission power determined based on the at least one of the plurality of power control parameter sets.

Example 2 may be combined with example 1 and further includes that transmitting a UE capability message indicating UE interference-aware uplink power control capabilities, where the plurality of power control parameter sets is configured based on the UE interference-aware uplink power control capabilities.

Example 3 may be combined example 2 and includes that the UE interference-aware uplink power control capabilities include at least one of: UE support for the interference-aware uplink power control, a maximum number of power control parameter sets for a transmission, a maximum number of pathloss reference signals for the transmission, or support for a power headroom report (PHR) based on the plurality of power control parameter sets.

Example 4 may be combined with any of examples 1-3 and includes that the plurality of power control parameter sets is associated with a unified transmission configuration indicator (TC).

Example 5 may be combined with any of examples 1-4 and includes that the first control signal further indicates a plurality of unified TCI states, and where each power control parameter set of the plurality of power control parameter sets is associated with a unified TCI state of the plurality of unified TCI states.

Example 6 may be combined with any of examples 1-5 and includes that a first power control parameter set of the plurality of power control parameter sets includes indicators to: a first target receiving power spectrum density (P0), a first fractional power control factor (α), first pathloss reference signals, and a first closed-loop index for closed-loop power control.

Example 7 may be combined with example 6 and includes that a second power control parameter set of the plurality of power control parameter sets includes indicators to at least one of: a second target receiving power spectrum density (P0), a second fractional power control factor (α), second pathloss reference signals, or a second closed-loop index for closed-loop power control.

Example 8 may be combined with any of examples 6-7 and includes that, when the second power control parameter set is missing an indicator to a power control parameter, using a corresponding power control parameter in the first power control parameter set for power control.

Example 9 may be combined with any of examples 1-8 and includes that the second control signal indicates the at least one of the plurality of power control parameter sets. sets.

Example 10 may be combined with example 1 and includes that the second control signal includes a downlink control information (DCI) selecting the at least one of the plurality of power control parameter sets.

Example 11 may be combined with example 1 and includes that the second control signal includes a medium access control (MAC) control element (CE) selecting the at least one of the plurality of power control parameter sets.

Example 12 may be combined with any of examples 1-11 and includes that the first control signal further indicates whether the plurality of power control parameter sets based power control is enabled.

Example 13 may be combined with any of examples 1-12 and further includes that determining at least one of a plurality of target transmission powers associated with the at least one of the plurality of power control parameter sets based on at least one of the first control signal or the second control signa, including determining a target transmission power for each associated power control parameter set; and determining the transmission power based on the at least one of the plurality of target transmission powers.

Example 14 may be combined example 13 and includes that the target transmission power for each associated power control parameter set k for a transmission occasion i is determined as P_{Tx,k}(i)=min{P_{CMAX}(i), P_{0,k}+αₖ×PLₖ+Δ_{BW}+Δ_{TF}+fₖ(i)}, wherein P_{CMAX}(i) indicates a maximum transmission power at the transmission occasion i; P_{0,k} is a target receiving power spectrum density for a power control parameter set k; αₖ is a fractional power control factor for the power control parameter set k; Δ_{BW} is a bandwidth factor; Δ_{TF} is a transmission format (TF) factor; fₖ(i) is a closed-loop power control factor for the power control parameter set k; PLₖ is a pathloss measured based on a pathloss reference signal for the power control parameter set k.

Example 15 may be combined example 13 and includes that the target transmission power for each associated power control parameter set k for a transmission occasion i is determined as P_{Tx,k}(i)=P_{0,k}+αₖ×PLₖ+Δ_{BW}+Δ_{TF}+fₖ(i), wherein P_{0,k} is a target receiving power spectrum density for a power control parameter set k; αₖ is a fractional power control factor for the power control parameter set k; Δ_{BW} is a bandwidth factor; A T_{F} is a transmission format (TF) factor; fₖ(i) is a closed-loop power control factor for the power control parameter set k; PLₖ is a pathloss measured based on a pathloss reference signal for the power control parameter set k.

Example 16 may be combined with any of examples 13-15 and includes that the transmission power for a transmission occasion i for the uplink signal is determined as P_{Tx}(i)=min{P_{CMAX}(i), P_{Tx,1}(i), . . . , P_{Tx,k}(i)}, where K is a number of the at least one of the plurality of power control parameter sets.

Example 17 may be combined with any of examples 13-15 and includes that the transmission power for a transmission occasion i for the uplink signal is determined as P_{Tx}(i)=min{P_{CMAX}(i),ma{P_{Tx,1}(i), . . . , P_{Tx,k}(i)}}, where K is a number of the at least one of the plurality of power control parameter sets.

Example 18 may be combined with any of examples 13-15 and includes that the transmission power for a transmission occasion i for the uplink signal is determined as

$${P}_{Tx} ( i ) = min \{ {P}_{CMAX} ( i ) , \frac{1}{K} {\sum }_{k = 1}^{K} {P}_{Tx , k} ( i ) \} ,$$

where K is a number of the at least one of the plurality of power control parameter sets.

Example 19 may be combined with any of examples 13-15 and includes that the transmission power for a transmission occasion i for the uplink signal is determined as

$${P}_{Tx} ( i ) = min \{ {P}_{CMAX} ( i ) , {\sum }_{k = 1}^{K} {β}_{k} {P}_{Tx , k} ( i ) \} ,$$

where K is a number of the at least one of the plurality of power control parameter sets and βₖ is a scaling factor for the power control parameter set k.

Example 20 may be combined with example 19 and includes that the scaling factor βₖ for the power control parameter set k is indicated by the first control signal.

Example 21 may be combined with any of examples 1, 13-15 and includes that the plurality of power control parameter sets are included in two lists, wherein the at least one of the plurality of power control parameter sets includes at least one of one or more power control parameter sets in a first list used for signal reception, or one or more power control parameter sets in a second list used for interference suppression.

Example 22 may be combined with example 21 and includes that the transmission power for the uplink signal is determined based on a first transmission power based on the one or more power control parameter sets in the first list and a second transmission power based on the one or more power control parameter sets in the second list.

Example 23 may be combined with example 22 and includes that wherein the first transmission power is determined based on a minimal, or a maximum, or an average target transmission power of the one or more power control parameter sets in the first list.

Example 24 may be combined with example 22 and includes that the second transmission power is determined based on a minimal, or an average target transmission power of the one or more power control parameter sets in the second list.

Example 25 may be combined with any of examples 22-24 and includes that the transmission power for a transmission occasion i is determined as

$${P}_{Tx} ( i ) = min \{ {P}_{CMAX} ( i ) , {P}_{Tx}^{( 1 )} ( i ) , {P}_{Tx}^{( 2 )} ( i ) \} ,$$

where P_{CMAX}(i) indicates a maximum transmission power at the transmission occasion i;

$${P}_{Tx}^{( 1 )} ( i )$$

is the first transmission power;

$${P}_{Tx}^{( 2 )} ( i )$$

is the second transmission power.

Example 26 may be combined with example 1 and further includes that transmitting a PHR including an actual power headroom (PH) determined based on a maximum transmission power and the transmission power determined based on the at least one of the plurality of power control parameter sets.

Example 26 may be combined with example 1 and further includes that transmitting a PHR including a reference PH determined based on a maximum transmission power and the transmission power determined based on one of the at least one of the plurality of power control parameter sets.

Example 28 may be combined with example 1 and further includes that transmitting a PHR including determining a reference PH determined based on a maximum transmission power and the transmission power determined based on all of the at least one of the plurality of power control parameter sets.

Example 29 may be combined with example 1 and further includes that transmitting a PHR in response to determining that a pathloss change for a pathloss reference signal in one of the plurality of power control parameter sets is larger than a threshold and a PHR timer expires or has expired.

Example 30 may be combined with example 1 and further includes that transmitting a PHR in response to determining that a minimal pathloss change for pathloss reference signals in the plurality of power control parameter sets is larger than a threshold and a PHR timer expires or has expired.

Example 31 may be combined with example 1 and further includes that transmitting a PHR in response to determining that a maximum pathloss change for pathloss reference signals in the plurality of power control parameter sets is larger than a threshold and a PHR timer expires or has expired.

Example 32 may be combined with example 1 and further includes that transmitting a PHR in response to determining that an average pathloss change for pathloss reference signals in the plurality of power control parameter sets is larger than a threshold and a PHR timer expires or has expired.

Example 33 is a UE, comprising: one or more radio frequency (RF) modems; a processor coupled to the one or more RF modems; and at least one memory storing executable instructions, the executable instructions to manipulate at least one of the processor or the one or more RF modems to perform the method of any of examples 1-32.

Example 34 is a method of wireless communication by a network entity, including: transmitting a first control signal indicating a plurality of power control parameter sets; transmitting a second control signal to trigger an uplink signal based on at least one of the plurality of power control parameter sets; and receiving the uplink signal with a transmission power determined based on at least one of the plurality of power control parameter sets.

Example 35 may be combined with example 34 and includes that receiving a UE capability message indicating UE interference-aware uplink power control capabilities, wherein the plurality of power control parameter sets is configured based on the UE interference-aware uplink power control capabilities.

Example 36 may be combined with example 35 and includes that the UE interference-aware uplink power control capabilities include at least one of: UE support for the interference-aware uplink power control, a maximum number of power control parameter sets for a transmission, a maximum number of pathloss reference signals for the transmission, or support for power headroom report (PHR) based on the plurality of power control parameter sets.

Example 37 may be combined with any of examples 34-36 and includes that the plurality of power control parameter sets is associated with a unified transmission configuration indicator (TCI).

Example 38 may be combined with any of examples 34-37 and includes that the first control signal further includes a plurality of unified TCI states, and wherein each power control parameter set of the plurality of power control parameter sets is associated with a TCT state of the plurality of unified TC states.

Example 39 may be combined with any of examples 34-38 and includes that a first power control parameter set of the plurality of power control parameter sets includes indicators to: a first target receiving power spectrum density (P0), a first fractional power control factor (α), first pathloss reference signals, and a first closed-loop index for closed-loop power control.

Example 40 may be combined with example 39 and includes that a second power control parameter set of the plurality of power control parameter sets includes indicators to: at least one of a second target receiving power spectrum density (P0), a second fractional power control factor (α), second pathloss reference signals, or a second closed-loop index for closed-loop power control.

Example 41 may be combined with any of examples 39-40 and includes that, when the second power control parameter set is missing an indicator to a power control parameter, a corresponding power control parameter in the first power control parameter set is used for power control.

Example 42 may be combined with any of examples 34-41 and includes that selecting the at least one of power control parameter sets, wherein the second control signal indicates the at least one of the plurality of power control parameter sets.

Example 43 may be combined with example 43 and includes that the second control signal includes a downlink control information (DCI) selecting the at least one of the plurality of power control parameter sets.

Example 44 may be combined with example 42 and includes that the second control signal includes a Medium Access Control (MAC) control element (CE) selecting the at least one of the plurality of power control parameter sets.

Example 45 may be combined with any of examples 34-44 and includes that the first control signal further indicates whether the plurality of power control parameter sets is enabled.

Example 46 may be combined with any of examples 34-45 and includes that the first control signal further indicates a scaling factor for each power control parameter set of the plurality of power control parameter sets for a user equipment (UE) to determine the transmission power.

Example 47 may be combined with any of examples 34-46 and includes that the plurality of power control parameter sets are included in two lists, and wherein the at least one of the plurality of power control parameter sets includes at least one of one or more power control parameter sets in a first list used for signal reception, or one or more power control parameter sets in a second list used for interference suppression.

Example 48 is a network entity, comprising: one or more radio frequency (RF) modems; a processor coupled to the one or more RF modems; and at least one memory storing executable instructions, the executable instructions to manipulate at least one of the processor or the one or more RF modems to perform the method of any of examples 34-47.

1. A method, by a user equipment (UE), comprising:
receiving an indication of a plurality of transmission configuration indicator (TCI) states associated with a plurality of power control parameter sets,
an uplink signal being based on at least one of the plurality of TCI states associated with the plurality of power control parameter sets; and
transmitting the uplink signal with a transmission power determined based on the at least one of the plurality of TCI states associated with the plurality of power control parameter sets.

2. (canceled)

3. (canceled)

4. (canceled)

5. The method of claim 1, wherein each power control parameter set of the plurality of power control parameter sets is associated with a TCI state of the plurality of TCI states.

6. The method of claim 1, wherein a first power control parameter set of the plurality of power control parameter sets includes indicators to: a first target receiving power spectrum density (P0), a first fractional power control factor (α), first pathloss reference signals, and a first closed-loop index for closed-loop power control.

7. The method of claim 6, wherein a second power control parameter set of the plurality of power control parameter sets includes indicators to at least one of: a second target receiving power spectrum density (P0), a second fractional power control factor (α), second pathloss reference signals, or a second closed-loop index for closed-loop power control.

8. (canceled)

9. (canceled)

10. The method of claim 1, further comprising receiving a downlink control information (DCI) for scheduling the uplink signal, wherein the DCI indicates a selection of the at least one of the plurality of TCI states associated with the plurality of power control parameter sets.

11. (canceled)

12. The method of claim 1, wherein the indication further indicates whether the plurality of power control parameter sets based power control is enabled.

13. The method of claim 1, further comprising:
determining at least one of a plurality of target transmission powers associated with the at least one of the plurality of power control parameter sets based on including determining a target transmission power for each associated power control parameter set; and
determining the transmission power based on the at least one of the plurality of target transmission powers.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A method, by a network entity, comprising:
transmitting an indication of a plurality of transmission configuration indicator (TCI) states associated with a plurality of power control parameter sets,
an uplink signal being based on at least one of the plurality of TCI states associated with the plurality of power control parameter sets; and
receiving the uplink signal with a transmission power determined based on at least one of the plurality of TCI states associated with the plurality of power control parameter sets.

35. (canceled)

36. (canceled)

37. (canceled)

38. The method of 34, wherein each power control parameter set of the plurality of power control parameter sets is associated with a TCT state of the plurality of TCI states.

39. The method of claim 34, wherein a first power control parameter set of the plurality of power control parameter sets includes indicators to: a first target receiving power spectrum density (P0), a first fractional power control factor (α), first pathloss reference signals, and a first closed-loop index for closed-loop power control.

40. The method of claim 39, wherein a second power control parameter set of the plurality of power control parameter sets includes indicators to: at least one of a second target receiving power spectrum density (P0), a second fractional power control factor (α), second pathloss reference signals, or a second closed-loop index for closed-loop power control.

41. (canceled)

42. (canceled)

43. The method of claim 34, further comprising transmitting a downlink control information (DCI) for scheduling the uplink signal, wherein the DCI selects the at least one of the plurality of unified TCI states associated with the plurality of power control parameter sets.

44. (canceled)

45. The method of claim 34, wherein the indication further indicates whether the plurality of power control parameter sets is enabled.

46. The method of claim 34, wherein the indication further indicates a scaling factor for each power control parameter set of the plurality of power control parameter sets for a user equipment (UE) to determine the transmission power.

47. (canceled)

48. (canceled)

49. An apparatus for wireless communication at a user equipment (UE), comprising:
a transceiver;
a processor; and
a memory coupled to the processor to store instructions, which when executed by the processor, cause the processor to:
receive an indication of a plurality of transmission configuration indicator (TCI) states associated with a plurality of power control parameter sets, an uplink signal being based on at least one of the plurality of TCI states associated with the plurality of power control parameter sets; and
transmit the uplink signal with a transmission power determined based on the at least one of the plurality of TCI states associated with the plurality of power control parameter sets.

50. The apparatus of claim 49, wherein each power control parameter set of the plurality of power control parameter sets is associated with a TCI state of the plurality of TCI states.

51. The apparatus of claim 49, wherein a first power control parameter set of the plurality of power control parameter sets includes indicators to: a first target receiving power spectrum density (P0), a first fractional power control factor (α), first pathloss reference signals, and a first closed-loop index for closed-loop power control, and
wherein a second power control parameter set of the plurality of power control parameter sets includes indicators to at least one of: a second target receiving power spectrum density (P0), a second fractional power control factor (α), second pathloss reference signals, or a second closed-loop index for closed-loop power control.

52. The apparatus of claim 49, wherein the apparatus is further caused to receive a downlink control information (DCI) for scheduling the uplink signal, wherein the DCI indicates a selection of the at least one of the plurality of TCI states associated with the plurality of power control parameter sets.

53. The apparatus of claim 49, wherein the indication further indicates whether the plurality of power control parameter sets based power control is enabled.

54. The apparatus of claim 49, wherein the processor is further caused to:
determine at least one of a plurality of target transmission powers associated with the at least one of the plurality of power control parameter sets including determining a target transmission power for each associated power control parameter set; and
determine the transmission power based on the at least one of the plurality of target transmission powers.
